(19) United States
(12) Patent Application Publication
(10) Pub. No.: US 2018/0073933 A1
(43) Pub. Date: Mar. 15, 2018

(54) DYNAMIC AND FAST LOCAL HOTSPOT SEARCH AND REAL TIME TEMPERATURE MONITORING

(71) Applicant: QUALCOMM Incorporated, San Diego, CA (US)

(72) Inventors: Mustafa Keskin, San Diego, CA (US); Masoud Roham, San Diego, CA (US); Mehdi Saeidi, San Diego, CA (US); Amy Derbyshire, Boulder, CO (US); Robert Gilmore, Poway, CA (US); Lew Chua-Eoan, Carlsbad, CA (US)

(21) Appl. No.: 15/263,101

(22) Filed: Sep. 12, 2016

(51) Int. Cl. G01K 1/02; G01K 1/14; G05D 23/19

(52) U.S. Cl. CPC G01K 1/026; G06F 12/1009; G05D 23/1917; G01K 1/14

(57) ABSTRACT

In certain aspects, a method for temperature monitoring comprises receiving temperature readings from a plurality of temperature sensors on a chip, and determining an average or a sum of the temperature readings from the temperature sensors. The sum may be a weighted sum of the temperature readings. The method also comprises computing a temperature at a location on the chip based on the average or sum of the temperature readings. The location may be located at approximately a centroid of the locations of the temperature sensors, an estimated hotspot location on the chip, or another location on the chip.

### BACKGROUND

### Field

Aspects of the present disclosure relate generally to temperature monitoring, and more particularly, to temperature monitoring of circuits.

### Background

Due to increases in chip integration and operating frequencies, power densities in chips have dramatically increased, resulting in higher chip temperatures. As a result, temperature monitoring is playing an increasingly important role in protecting chips from damage due to overheating. In this regard, temperature sensors may be integrated on a chip to monitor temperature at various locations on the chip. Temperature readings from the temperature sensors may be input to a temperature manager that manages blocks of circuitry (e.g., central processing units (CPUs)) on the chip based on the temperature readings to prevent overheating.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

A first aspect relates to a system. The system comprises a plurality of temperature sensors on a chip, and a multiplexer having a plurality of inputs and an output, wherein each of the inputs is coupled to a respective one of the temperature sensors. The system also comprises an analog-to-digital converter (ADC) coupled to the output of the multiplexer, wherein the ADC is configured to convert an output signal from the output of the multiplexer into a digital signal. The system further comprises a temperature manager configured to instruct the multiplexer to select one or more of the temperature sensors, to receive the digital signal from the ADC, and to compute a temperature based on the digital signal. The multiplexer is configured to generate the output signal based on one or more temperature readings from the selected one or more of the temperature sensors.

A second aspect relates to a method for temperature monitoring. The method comprises receiving temperature readings from a plurality of temperature sensors on a chip, determining an average or a sum of the temperature readings, and computing a temperature at a location on the chip based on the average or sum of the temperature readings.

A third aspect relates to a method for performing a search. The method comprises receiving sensor readings from a plurality of sensors on a chip, dividing a region of the chip into a first region and a second region, determining a first value for the first region based on a first subset of the sensor readings, and determining a second value for the second region based on a second subset of the sensor readings. The method also comprises comparing the first value with the second value, and narrowing the search to one of the first and second regions corresponding to a highest one of the first and second values.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 shows an example of a chip with temperature management according to certain aspects of the present disclosure.

FIG. 2 shows another example of a chip with temperature management according to certain aspects of the present disclosure.

FIG. 3 shows an exemplary implementation of a multiplexer according to certain aspects of the present disclosure.

FIG. 4 shows another exemplary implementation of a multiplexer according to certain aspects of the present disclosure.

FIG. 5 shows still another exemplary implementation of a multiplexer according to certain aspects of the present disclosure.

FIG. 6 is a flowchart illustrating a method for temperature management according to certain aspects of the present disclosure.

FIG. 7A shows an example of estimating the temperature at a location on a chip based on temperature readings from multiple temperature sensors according to certain aspects of the present disclosure.

FIG. 7B shows another example of estimating the temperature at a location on a chip based on temperature readings from multiple temperature sensors according to certain aspects of the present disclosure.

FIG. 7C shows still another example of estimating the temperature at a location on a chip based on temperature readings from multiple temperature sensors according to certain aspects of the present disclosure.

FIG. 8 shows an exemplary implementation of a multiplexer capable of providing a weighted sum of temperature readings according to certain aspects of the present disclosure.

FIG. 9 shows an exemplary implementation of a variable resistor according to certain aspects of the present disclosure.

FIG. 10 shows another exemplary implementation of a multiplexer capable of providing a weighted sum of temperature readings according to certain aspects of the present disclosure.

FIG. 11 shows an exemplary implementation of a current scaler according to certain aspects of the present disclosure.

FIG. 12 shows an exemplary layout of temperature sensors according to certain aspects of the present disclosure.

FIG. 13A shows an example of a binary search in which a region of a chip is divided into two regions according to certain aspects of the present disclosure.

FIG. 13B shows an example of the binary search in which one of the two regions shown in FIG. 13A is further divided into two regions according to certain aspects of the present disclosure.

FIG. 13C shows an example of the binary search in which one of the two regions shown in FIG. 13B is further divided into two regions according to certain aspects of the present disclosure.

FIG. 14 shows an example of a power distribution network supplying currents to blocks on a chip according to certain aspects of the present disclosure.

FIG. 15 shows an exemplary implementation of a current sensor according to certain aspects of the present disclosure.

FIG. 16 shows an example of a current monitoring system according to certain aspects of the present disclosure.

FIG. 17 shows an example of a power management system according to certain aspects of the present disclosure.

FIG. 18 is a flowchart showing a method for temperature monitoring according to certain aspects of the present disclosure.

FIG. 19 is a flowchart showing a method for performing a search according to certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

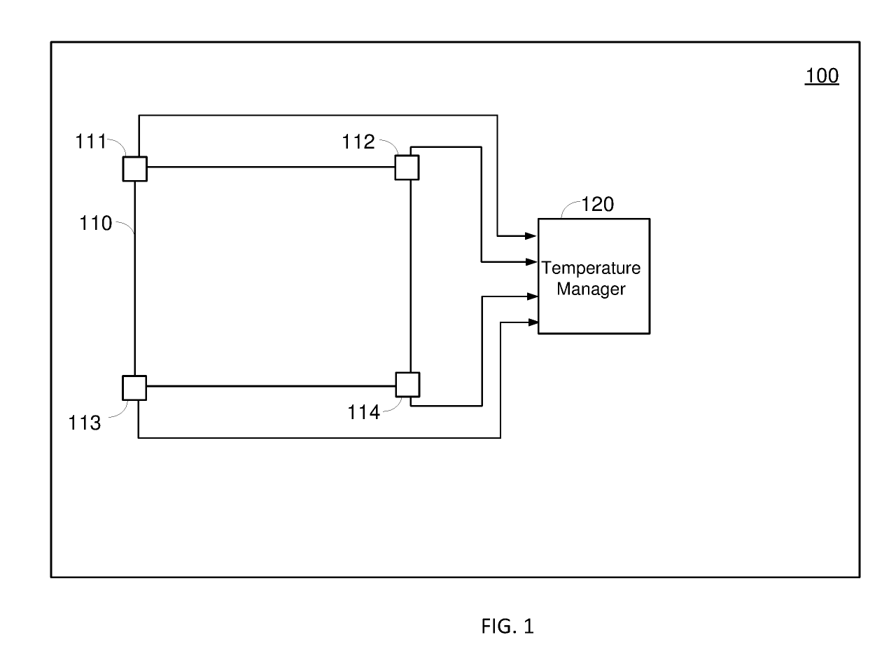

Temperature sensors may be integrated on a chip to monitor temperature at various locations on the chip. In this regard, FIG. 1 shows an example of a chip 100 (die) with temperature management including multiple temperature sensors 111-114, and a temperature manager 120. The temperature sensors 111-114 may be placed at strategic locations on the chip 100 for monitoring temperature, e.g., in a region 110 of the chip 100. The region 110 may include one or more blocks of circuitry (e.g., processors). The temperature sensors 111-114 may be placed at or around estimated hotspot locations in the region 110, distributed uniformly in the region 110, distributed along a perimeter (boundary) of the region 110, etc. It is to be appreciated that the placement and number of temperature sensors 111-114 shown in FIG. 1 is exemplary only, and therefore that the present disclosure is not limited to this example.

Each temperature sensor 111-114 may be implemented with a temperature-sensitive circuit configured to output a voltage or current that is a function of temperature at the respective sensor location. For example, the temperature-sensitive circuit may output a voltage or current that is approximately a linear function of absolute temperature over a temperature range. Since the output voltage or current of the temperature-sensitive circuit is a function of temperature, the output voltage or current indicates the temperature at the respective sensor location, and therefore provides a temperature reading (temperature measurement) at the respective sensor location. The temperature-sensitive circuit may be implemented with a bandgap-temperature circuit, one or more diode-connected transistors, a temperature-sensitive resistor, etc.

In operation, the temperature manager 120 receives temperature readings (temperature measurements) from the temperature sensors 111-114, where each temperature reading indicates the temperature sensed at the location of the respective sensor. The temperature reading from each temperature sensor 111-114 may be digitized using a respective analog-to-digital converter (ADC) (not shown) before going to the temperature manager 120, allowing the temperature manager 120 to process the temperature reading in the digital domain. For example, if the temperature reading is in the form of a voltage or current that is a function of temperature, the ADC may convert the voltage or current into a temperature reading in the digital domain.

When the temperature manager 120 receives a temperature reading from one of the temperature sensors 111-114, the temperature manager 120 may compare the temperature reading with a temperature threshold. The temperature threshold may correspond to an upper temperature boundary for safe operation of the chip 100. If a temperature reading exceeds the temperature threshold, then the temperature manager 120 may take steps to reduce the temperature to prevent overheating. For example, if the region 110 includes a processor (e.g., CPU) on the chip 100, then the temperature manager 120 may reduce the temperature by reducing the operating frequency of the processor and/or reducing the supply voltage of the processor. Reducing the operating frequency and/or supply voltage of the processor reduces the temperature by reducing the dynamic power dissipation of the processor. In extreme cases where the temperature reading exceeds the temperature threshold by a large amount, the temperature manager 120 may shut down the processor to prevent damage to the chip 100.

The temperature manager 120 in FIG. 1 receives temperature readings from each temperature sensor 111-114 individually. In cases where temperatures on the chip 100 are well below the temperature threshold (e.g., 10° C. or more below the temperature threshold), having the temperature manager 120 process individual temperature readings from the temperature sensors 111-114 may consume more power than necessary to safely manage temperature.

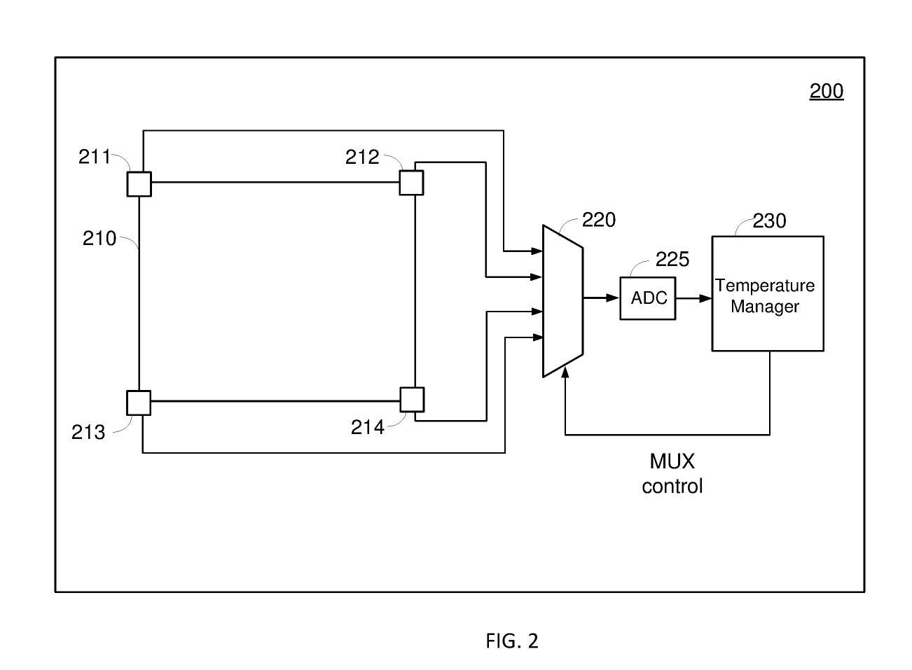

FIG. 2 shows an example of a chip 200 with temperature management according to certain aspects of the present disclosure. The chip 200 includes multiple temperature sensors 211-214, a multiplexer 220, an analog-to-digital converter (ADC) 225, and a temperature manager 230. The temperature sensors 211-214 may be placed at strategic locations on the chip 200 for monitoring temperature, e.g., in a region 210 of the chip 200, as discussed above. Each temperature sensor 211-214 may be implemented with a temperature-sensitive circuit that outputs a temperature reading in the form of a voltage or current that is a function of temperature at the respective sensor location, as discussed above. The multiplexer 220 has multiple inputs and an output, in which each input is coupled to a respective one of the temperature sensors 211-214, and the output is coupled to the ADC 225. The ADC 225 is configured to convert the output signal of the multiplexer 220 into a digital signal and output the digital signal to the temperature manager 230.

The multiplexer 220 is configured to selectively couple one or more of the temperature sensors 211-214 to the ADC 225 at a time based on a multiplexer control signal (denoted “MUX control” in FIG. 2) from the temperature manager 230. For example, the temperature manager 230 may command the multiplexer 220 to couple each temperature sensor 211-214 to the ADC 225 one at a time. In this example, the ADC 225 receives a temperature reading (temperature measurement) from each temperature sensor one at a time. The ADC 225 converts each temperature reading into digital form, and outputs each temperature reading in digital form to the temperature manager 230. The temperature manager 230 may compare each temperature reading with the temperature threshold, and initiate temperature mitigation if at least one of the temperature readings exceeds the temperature threshold. For instance, if the region 210 includes a processor (e.g., CPU) on the chip 200, then the temperature manager 230 may perform temperature mitigation by reducing the operating frequency of the processor and/or reducing the supply voltage of the processor, as discussed above. In this example, the multiplexer 220 may cycle through the temperature sensors 211-214 one at a time to monitor the temperature at each sensor location.

In another example, the temperature manager 230 may command the multiplexer 220 to couple two or more of the temperature sensors 211-214 to the ADC 225 at the same time. In this example, the multiplexer 220 may be configured to average the temperature readings (temperature measurements) from the two or more temperature sensors, and output the average temperature reading to the ADC 225. The ADC 225 may then convert the average temperature reading into digital form, and output the average temperature reading in digital form to the temperature manager 230. This allows the temperature manager 230 to receive a single average temperature reading from the two or more temperature sensors rather than individual temperature readings.

Alternatively, the multiplexer 220 may be configured to sum the temperature readings (temperature measurements) from the two or more temperature sensors, and output the sum of the temperature readings to the ADC 225. The ADC 225 may then convert the sum of the temperature readings into digital form, and output the sum of the temperature readings in digital form to the temperature manager 230. In this aspect, the temperature manager 230 may convert the sum of the temperature readings into an average temperature reading by dividing the sum of the temperature readings by the number of temperature sensors contributing to the sum.

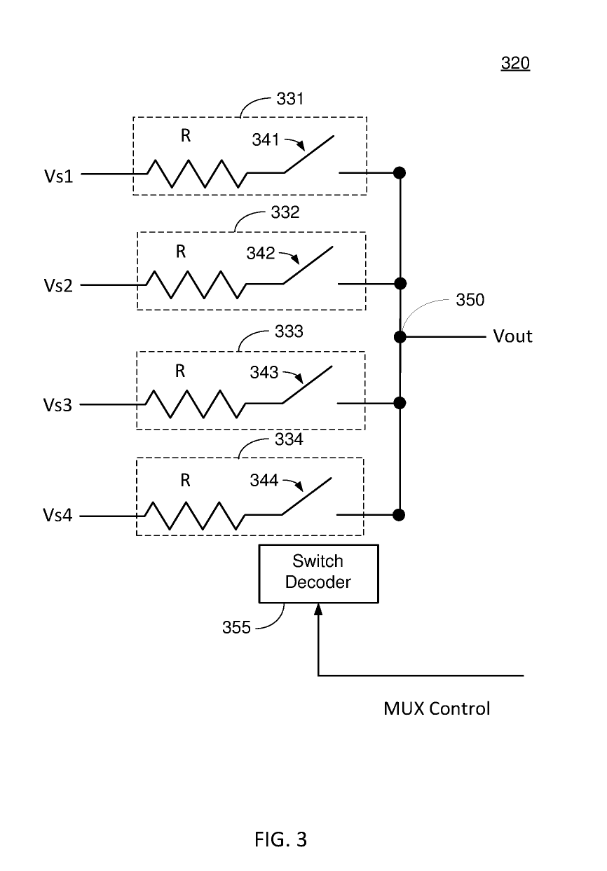

Exemplary implementations of the multiplexer 220 will now be discussed below with reference to FIGS. 3-5.

FIG. 3 shows an exemplary implementation of a multiplexer 320 according to certain aspects of the present disclosure. The multiplexer 320 may be used to implement the multiplexer 220 in FIG. 2. In this example, the multiplexer 320 includes multiple segments 331-334, and a switch decoder 355. Each segment 331-334 is coupled between a respective one of the temperature sensors 211-214 (not shown in FIG. 3) and node 350. Node 350 is coupled to the ADC 225 (not shown in FIG. 3). Each segment 331-334 includes a respective resistor R and a respective switch 341-344 coupled in series, as shown in FIG. 3. The resistances of the resistors in the segments may be approximately the same.

The switch decoder 355 is configured to receive the multiplexer control signal (denoted “MUX control” in FIG. 3) from the temperature manager 230, and to selectively open and/or close the switches 341-344 based on the multiplexer control signal. For example, the multiplexer control signal may indicate which ones of the switches are to be opened and/or which ones of the switches are to be closed. The switch decoder 355 may then open and/or close the switches accordingly. For ease of illustration, the individual connections between the switches 341-344 and the switch decoder 355 are not shown.

In the example shown in FIG. 3, each of the temperature sensors 211-214 provides a temperature reading in the form of a voltage Vs1-Vs4 that is a function of temperature at the respective sensor location. Thus, in this example, each of the segments 331-334 receives a voltage from the respective temperature sensor indicating the temperature at the respective sensor location.

The multiplexer 320 allows the temperature manager 230 to selectively couple any one of the temperature sensors 211-214 to the ADC 225 at a time. For example, the temperature manager 230 may command the multiplexer 320 to couple a particular temperature sensor to the ADC 225 by commanding the multiplexer 320 to close the switch in the respective segment and to open the switches in the remaining segments. In this case, the output voltage (denoted “Vout” in FIG. 3) may be approximately equal to the voltage from the selected temperature sensor assuming the input impedance of the ADC 225 is high relative to the resistance of the resistor R in the respective segment.

The multiplexer 320 also allows the temperature manager 230 to selectively couple two or more of the temperature sensors 211-214 to the ADC 225 at the same time. For example, the temperature manager 230 may command the multiplexer 320 to couple all of the temperature sensors to the ADC 225 by commanding the multiplexer 320 to close the switches in all of the segments. In this case, the output voltage (denoted “Vout” in FIG. 3) at node 350 may be approximately equal to an average of the voltages of the temperature sensors. Thus, in this case, the output voltage of the multiplexer 320 is approximately equal to the average voltage of the temperature sensors, and therefore provides an average temperature reading.

In general, the multiplexer 320 allows the temperature manager 230 to select any subset of the temperature sensors 211-214. For example, the temperature manager 230 may command the multiplexer 320 to couple a subset of the temperature sensors to the ADC 225 by commanding the multiplexer 320 to close the switches in the respective segments (i.e., the segments corresponding to the selected subset of temperature sensors) and to open the switch(es) in the remaining segment(s). In this case, the multiplexer provides an average temperature reading for the temperature sensors in the selected subset.

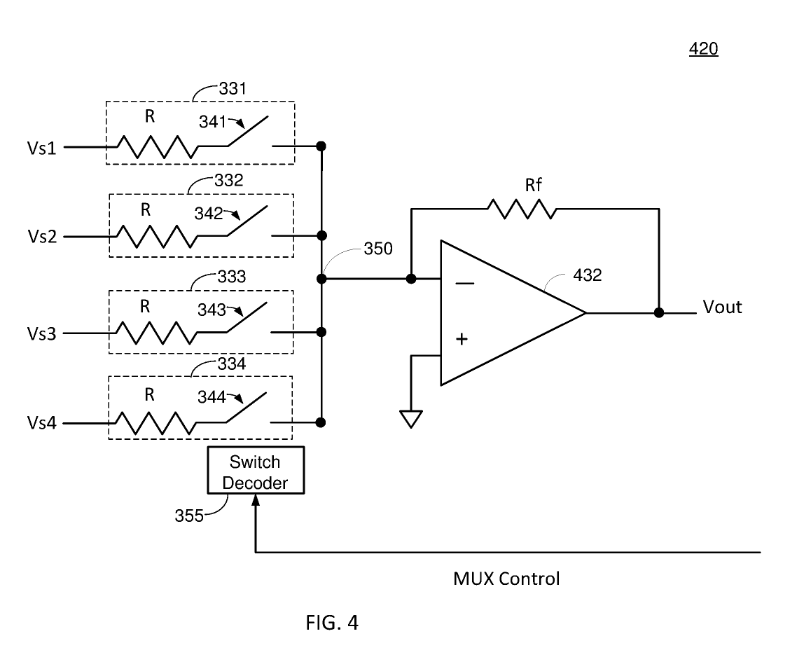

FIG. 4 shows another exemplary implementation of a multiplexer 420 according to certain aspects of the present disclosure. The multiplexer 420 may be used to implement the multiplexer 220 in FIG. 2. In this example, the multiplexer 420 includes the segments 331-334 and switch decoder 355 from the multiplexer 320 in FIG. 3. The multiplexer 420 further includes a summing amplifier 432 and a feedback resistor Rf. The feedback resistor Rf is coupled between a first input of the amplifier 432 and the output of the amplifier 432. A second input of the amplifier 432 may be coupled to ground, as shown in FIG. 4. The first input of the amplifier 432 is also coupled to node 350, where each segment 331-334 is coupled between the respective temperature sensor 211-214 and node 350, as discussed above. In this example, the output of the multiplexer 420 may be taken at the output of the amplifier 432.

The multiplexer 420 allows the temperature manager 230 to selectively couple any one of the temperature sensors 211-214 to the ADC 225 at a time. For example, the temperature manager 230 may command the multiplexer 420 to couple a particular temperature sensor to the ADC 225 by commanding the multiplexer 420 to close the switch in the respective segment and to open the switches in the remaining segments. In this case, the output voltage (denoted “Vout”) is given by:

$$Vout = - \frac{Rf}{R} \cdot Vs \qquad ( Eq . 1 )$$

where Vs is the voltage of the selected temperature sensor. As shown in equation 1, the output voltage is proportional to the voltage of the selected temperature sensor, and therefore provides a temperature reading for the selected temperature sensor.

The multiplexer 420 also allows the temperature manager 230 to selectively couple two or more of the temperature sensors 211-214 to the ADC 225 at the same time. For example, the temperature manager 230 may command the multiplexer 420 to couple all of the temperature sensors to the ADC 225 by commanding the multiplexer 420 to close the switches in all of the segments. In this case, the output voltage (denoted “Vout”) is given by:

$$Vout = - \frac{Rf}{R} \cdot ( Vs 1 + Vs 2 + Vs 3 + Vs 4 ) \qquad ( Eq . 2 )$$

where Vs1-Vs4 are the voltages of temperature sensors 211-214, respectively. As shown in equation 2, the output voltage is proportional to the sum of the voltages of the temperature sensors, and therefore provides a sum of the temperature readings from the temperature sensors 211-214.

In general, the multiplexer 420 allows the temperature manager 230 to select any subset of the temperature sensors 211-214. For example, the temperature manager 230 may command the multiplexer 420 to couple a subset of the temperature sensors to the ADC 225 by commanding the multiplexer 420 to close the switches in the respective segments and to open the switch(es) in the remaining segment(s). In this case, the multiplexer provides a sum of the temperature readings from the temperature sensors in the selected subset.

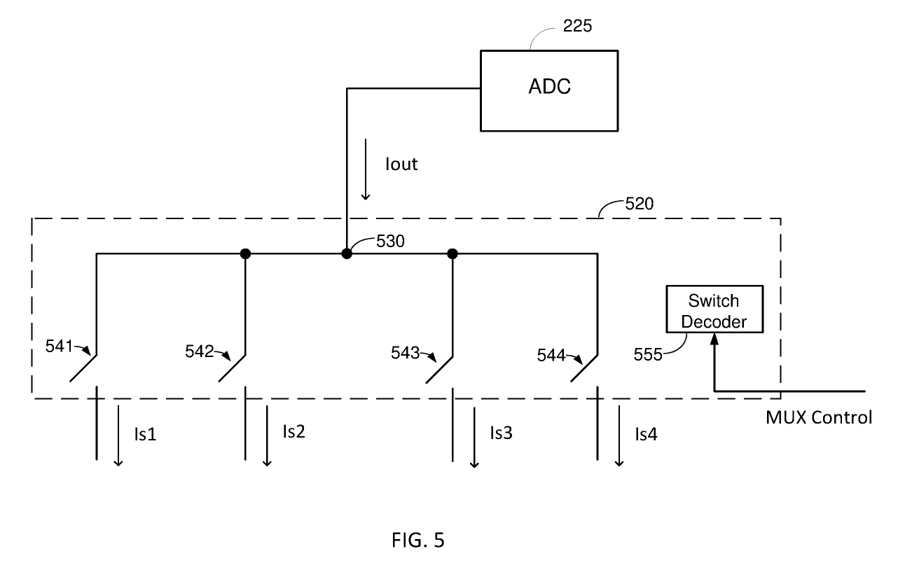

FIG. 5 shows another exemplary implementation of a multiplexer 520 according to certain aspects of the present disclosure. The multiplexer 520 may be used to implement the multiplexer 220 in FIG. 2. In this example, each of the temperature sensors 211-214 provides a temperature reading in the form of a current Is1-Is4 that is a function of temperature at the respective sensor location.

The multiplexer 520 includes multiple switches 541-544 and a switch decoder 555, in which each switch is coupled between a respective one of the temperature sensors 211-214 (not shown in FIG. 3) and node 530. Node 530 is coupled to the ADC 225, as shown in FIG. 5. The switch decoder 555 is configured to receive the multiplexer control signal (denoted “MUX control” in FIG. 5) from the temperature manager 230, and to selectively open and/or close the switches 541-544 based on the multiplexer control signal. For example, the switch decoder 555 may operate in a similar manner as the switch decoder 355 in FIG. 3 discussed above. For ease of illustration, the individual connections between the switches 541-544 and the switch decoder 555 are not shown.

The multiplexer 520 allows the temperature manager 230 to selectively couple any one of the temperature sensors 211-214 to the ADC 225 at a time. For example, the temperature manager 230 may command the multiplexer 520 to couple a particular temperature sensor to the ADC 225 by commanding the multiplexer 520 to close the switch corresponding to the selected temperature sensor and to open the remaining switches. In this case, the multiplexer 520 outputs the current from the selected temperature sensor. The ADC 225 may convert the sensor current into a digital temperature reading. For example, the ADC 225 may convert the current into a voltage by passing the current through a resistor (not shown), and then convert the voltage into the digital temperature reading.

The multiplexer 520 also allows the temperature manager 230 to selectively couple two or more of the temperature sensors 211-214 to the ADC 225 at the same time. For example, the temperature manager 230 may command the multiplexer 520 to couple all of the temperature sensors to the ADC 225 by commanding the multiplexer 520 to close all of the switches. In this case, the temperature sensors are shorted together, and the output current of the multiplexer 520 (denoted “Iout”) is approximately equal to the sum of the currents of the temperature sensors. Thus, in this case, the output of the multiplexer 520 provides a sum of the temperature readings from the temperature sensors 211-214.

In general, the multiplexer 520 allows the temperature manager 230 to select any subset of the temperature sensors 211-214. For example, the temperature manager 230 may command the multiplexer 520 to couple a subset of the temperature sensors to the ADC 225 by commanding the multiplexer 520 to close the respective switches and to open the remaining switch(es). In this case, the temperature sensors in the selected subset are shorted together, and the multiplexer 520 provides a sum of the temperature readings from the temperature sensors in the selected subset.

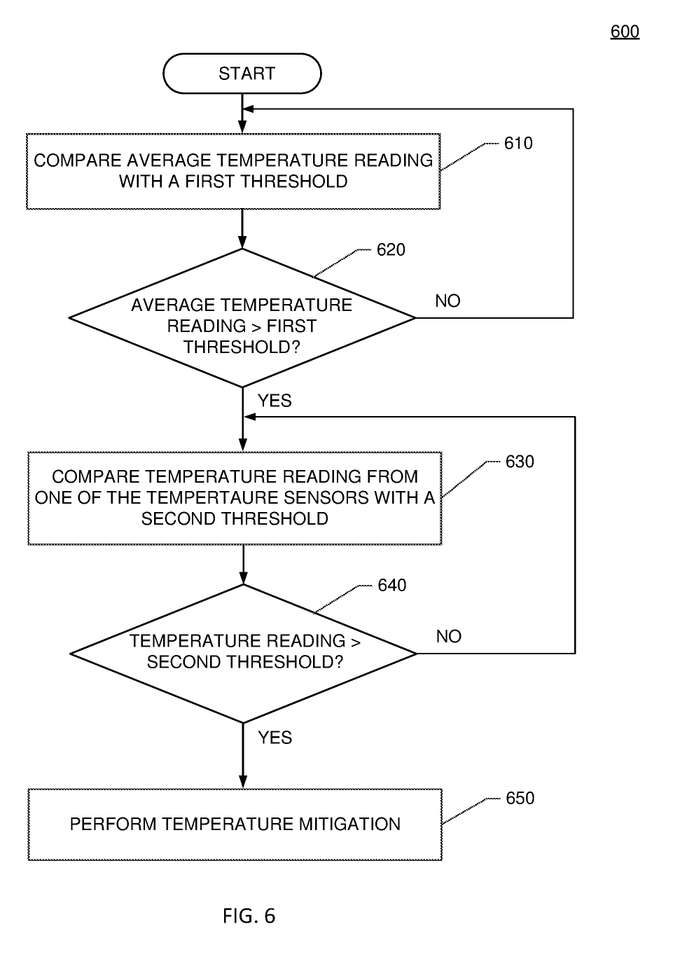

FIG. 6 shows an exemplary temperature-management method 600 that may be performed by the temperature manager 230 according to certain aspects.

At step 610, the temperature manager 230 compares an average of the temperature readings from two or more temperature sensors 211-214 with a first temperature threshold. The first temperature threshold is below a second temperature threshold used to trigger temperature mitigation, as discussed further below. For example, the first temperature threshold may be 10° C. or more below the second temperature threshold. To obtain the average temperature reading, the temperature manager 230 may command the multiplexer 220 to couple the two or more temperature sensors to the temperature manager 230, as discussed above. The multiplexer 220 may be implemented using any of the multiplexers 320, 420 and 520 shown in FIGS. 3-5.

At step 620, the temperature manager 230 determines whether the average temperature reading exceeds the first temperature threshold. If the average temperature reading does not exceed the first temperature threshold, then the temperature manager 230 repeats steps 610 and 620 (e.g., after a predetermined time interval). If the average temperature reading exceeds the first temperature threshold, then the temperature manager 230 proceeds to step 630.

At step 630, the temperature manager 230 compares a temperature reading from one of the temperature sensors 211-214 with the second temperature threshold. The second temperature threshold may correspond to an upper temperature boundary for safe operation of the chip 200.

At step 640, the temperature manager 230 determines whether the temperature reading exceeds the second threshold. If the temperature reading does not exceed the second temperature threshold, then the temperature manager 120 repeats steps 630 and 640. For example, the temperature manager 230 may repeat steps 630 and 640 using a temperature reading from another one of the temperature sensors 211-214. In this example, the temperature manager 230 may cycle through the temperature sensors 211-214 as steps 630 and 640 are repeated. If the temperature reading in step 640 exceeds the second temperature threshold, then the temperature manager 230 proceeds to step 650.

At step 650, the temperature manager 230 performs temperature mitigation. For example, if the region 210 includes a processor (e.g., CPU) on the chip 200, then the temperature manager 230 may perform temperature mitigation by reducing the operating frequency of the processor and/or reducing the supply voltage of the processor.

Thus, in the example in FIG. 6, the temperature manager 230 may initially check the average temperature reading rather than individual temperature readings from the temperature sensors 211-214. This may be done to conserve power when temperatures on the chip 200 are well below the upper temperature boundary for safe operation. When the average temperature reading exceeds the first temperature threshold, the temperature manager 230 begins monitoring individual temperature readings from the temperature sensors 211-214, and initiates temperature mitigation when one of the temperature readings exceeds the second temperature threshold.

As discussed above, at step 610, the temperature manager 230 compares the average of the temperature readings from two or more temperature sensors 211-214 with the first temperature threshold. For the embodiments in which the multiplexer 220 provides the sum of the temperature readings from the two or more temperature sensors, the temperature manager 230 may determine the average temperature reading by dividing the sum of the temperature readings by the number of temperature sensors contributing to the sum. Alternatively, the temperature manager 230 may compare the sum of the temperature readings with a product of the first temperature threshold and the number of temperature sensors contributing to the sum. This is equivalent to comparing the average temperature reading with the first temperature threshold. Thus, in the present disclosure, it is to be understood that comparing the average temperature reading with the first temperature threshold also covers comparing the sum of the temperature readings with the product of the first temperature threshold and the number of temperature sensors contributing to the sum.

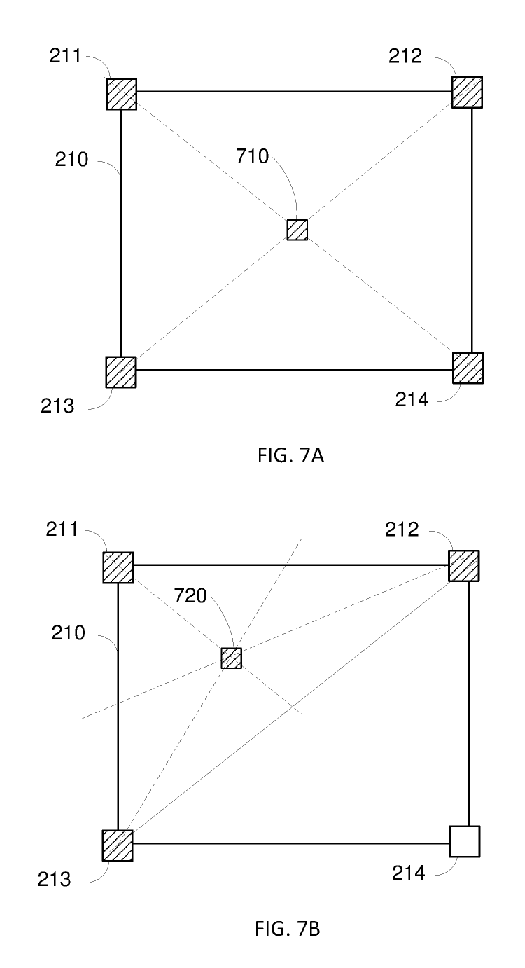

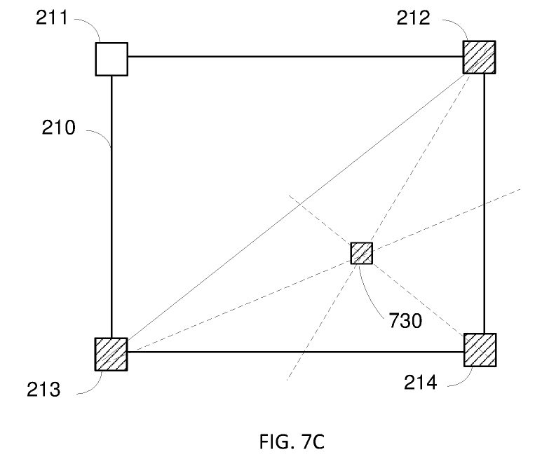

In certain aspects, the temperature manager 230 may estimate the temperature at a location within the region 210 based on an average of the temperature readings from the temperature sensors. The location within the region 210 may correspond to an average of the locations of the temperature sensors 211-214. In this regard, FIG. 7A shows a location 710 that corresponds to an average of the locations of the temperature sensors 211-214 (e.g., centroid of the temperature sensors 211-214). For example, if the sensor locations are given in x and y coordinates, then the x coordinate of location 710 may be given by the average of the x coordinates of the sensor locations and the y coordinate of location 710 may be given by the average of the y coordinates of the sensor locations. In this example, the temperature manager may estimate the temperature at location 710 based on the average of the temperature readings from the temperature sensors as follows:

T_{Est}=β·T_{Avg} (Eq. 3)

where T_{Est} is the estimated temperature at location 710, T_{Avg} is the average of the temperature readings, and β is a coefficient. The value of coefficient β may be determined by running thermal simulations of the chip 200 or testing a physical chip. For example, the temperatures at the sensor locations and the temperature at location 710 may be determined by running a thermal simulation of the chip or testing a physical chip. In this example, the value of coefficient β may be computed by averaging the temperatures at the sensor locations, and dividing the temperature at location 710 by the average temperature. It is to be appreciated that the value of coefficient β may also be determined using other techniques.

In another example, the temperature manager 230 may estimate the temperature at location 710 based on the sum of the temperature readings from the temperature sensors as follows:

T_{Est}=β·(Tₛ₁+Tₛ₂+Tₛ₃+Tₛ₄) (Eq. 4)

where T_{Est} is the estimated temperature at location 710, Tₛ₁ to Tₛ₄ are the temperature readings from temperature sensors 211-214, respectively, and β′ is a coefficient. Coefficient β′ may be approximately equal to coefficient β divided by the number of temperature sensors contributing to the sum (e.g., four in this example).

In general, the temperature manager 230 may estimate the temperature at different locations using different subsets of the temperature sensors 211-214. In this regard, FIG. 7B shows an example in which the temperature manager 230 estimates the temperature at a location 720 corresponding to the average of the locations of temperature sensors 211-213 (e.g., centroid of temperature sensors 211-213). In this example, the temperature manager 230 may command the multiplexer 220 to select temperature sensors 211-213, which are shaded in FIG. 7B. In this example, the temperature manager 230 may estimate the temperate at location 720 based on equation 3, in which T_{Avg} is the average temperature reading for temperature sensors 211-213. The value of coefficient β for this case may differ from the value of coefficient β for the case where all of the temperature sensors are selected. The value of coefficient β for this case may be determined in the manner discussed above. For example, the temperatures at the locations of temperature sensors 211-213 and the temperature at location 720 may be determined by running a thermal simulation of the chip or testing a physical chip. In this example, the value of coefficient β may be computed by averaging the temperatures at the locations of temperature sensors 211-213, and dividing the temperature at location 720 by the average temperature. The temperature manager 230 may also estimate the temperate at location 720 based on equation 4 using the sum of the temperature readings from the selected temperature sensors 211-213.

FIG. 7C shows another example in which the temperature manager 230 estimates the temperature at a location 730 corresponding to the average of the locations of temperature sensors 212-214 (e.g., centroid of temperature sensors 212-214). In this example, the temperature manager 230 may command the multiplexer 220 to select temperature sensors 212-214, which are shaded in FIG. 7C. In this example, the temperature manager 230 may estimate the temperate at location 730 based on equation 3, in which T_{Avg} is the average temperature reading for temperature sensors 212-214.

Thus, the temperature manager 230 is able to estimate the temperature at different locations by having the multiplexer 220 select different subsets of the temperature sensors 211-214. Although four temperature sensors 211-214 are shown in the examples in FIG. 7A-7C for ease of illustration, it is to be appreciated that the chip 200 may include a larger number of temperature sensors.

In certain aspects, two or more temperature sensors may be placed on the chip based on an estimated hotspot location on the chip. For example, the two or more temperature sensors may be placed on the chip such that the average of the locations of the two or more temperature sensors (centroid of the two or more temperature sensors) is located at or near the hotspot location. This allows the temperature manager 230 to estimate the temperature at the hotspot location. The hotspot location may be estimated by running thermal simulations of the chip and looking for a location on the chip with a peak temperature.

An advantage of this embodiment is that it allows the temperature manager 230 to estimate the temperature at the hotspot location without having to physically place a temperature sensor at the hotspot location which may be difficult. This is because the hotspot may be located in an area of the chip densely populated with transistors and interconnecting metal wires.

In certain aspects, the hotspot location may change for different operating conditions of the chip (e.g., depending on which processors on the chip are active at a given time). The hotspot locations for the different operating conditions may be determined by running thermal simulations of the chip for each operating condition and looking for a location on the chip with a peak temperature for each operating condition. In this example, the temperature sensors may be placed on the chip such that different subsets of the temperature sensors correspond to different hotspot locations. More particularly, each subset of the temperature sensors may be placed on the chip such that the average of the locations of the temperature sensors in the subset (centroid of the temperature sensors in the subset) is located at or near the respective hotspot location. It is to be appreciated that two or more subsets may have one or more temperature sensors in common.

In certain aspects, the temperature manager 230 may estimate the temperature at a location on the chip based on temperature readings from all of the temperature sensors or a subset of the temperature sensors, as discussed above, and compare the estimated temperature with a temperature threshold. The location may correspond to an estimated hotspot location on the chip 200, and the temperature threshold may correspond to an upper temperature boundary for safe operation of the chip. If the estimated temperature exceeds the temperature threshold, then the temperature manager 230 may perform temperature mitigation, as discussed above.

In certain aspects, the temperature manager 230 may estimate the temperature at a location on the chip based on temperature readings from all of the temperature sensors or a subset of the temperature sensors, as discussed above, and compare the estimated temperature with the second temperature threshold at step 630 in FIG. 6. At step 640, the temperature manager 230 may determine whether the estimated temperature exceeds the second threshold. If the estimated temperature does not exceed the second temperature threshold, then the temperature manager 230 repeats steps 630 and 640. For example, the temperature manager 230 may repeat steps 630 and 640 using an estimated temperature at another location on the chip or using an individual temperature reading from one of the temperature sensors. If the estimated temperature exceeds the second temperature threshold, then the temperature manager 230 may perform temperature mitigation at step 650, as discussed above.

In certain aspects, the temperature manager 230 may estimate the temperature at a location on the chip based on a weighted sum of temperature readings from two or more temperature sensors. The location may be within the region 210 or outside the region 210. For example, the temperature manager 230 may estimate the temperature at a location on the chip as follows:

T_{Est}=α₁Tₛ₁+α₂Tₛ₂+α₃Tₛ₃+α₄Tₛ₄ (Eq. 5)

where T_{ESL} is the estimated temperature at the location, Tₛ₁ to Tₛ₄ are the temperature readings from temperature sensors 211-214, respectively, and α₁ to α₄ are weights assigned to temperature sensors 211-214, respectively. As shown in equation 5, the temperature readings from the temperature sensors may be weighted differently by assigning different weights to the temperature sensors 211-214. Thus, the temperature reading from a temperature sensor assigned a higher weight is weighted more than a temperature reading from a temperature sensor assigned a lower weight. Methods for determining the weights will be discussed further below.

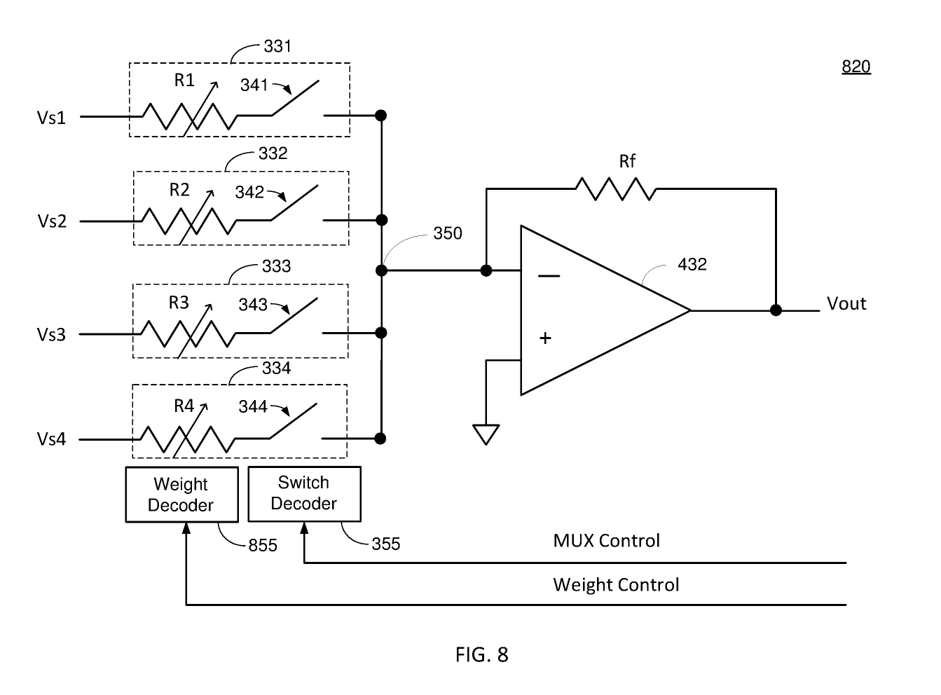

In these aspects, the multiplexer 220 may be configured to provide a weighted sum of temperature readings from two or more selected temperature sensors. In this regard, FIG. 8 shows an exemplary implementation of a multiplexer 820 capable of providing a weighted sum of temperature readings from two or more of the temperature sensors 211-214. The multiplexer 820 may be used to implement the multiplexer 220 in FIG. 2. In this example, each of the temperature sensors 211-214 provides a temperature reading in the form of a voltage Vs1-Vs4 that is a function of temperature at the respective sensor location.

The multiplexer 820 is similar to the multiplexer 420 shown in FIG. 4 except that each segment 331-334 comprises a respective variable resistor R1-R4 and the multiplexer 820 further comprises a weight decoder 855. In this example, when all of the temperature sensors are selected, the output voltage (denoted “Vout”) of the multiplexer 820 is given by:

$$Vout = - Rf \cdot ( \frac{Vs 1}{R 1} + \frac{Vs 2}{R 2} + \frac{Vs 3}{R 3} + \frac{Vs 4}{R 3} ) \qquad ( Eq . 6 )$$

where Vs1-Vs4 are the voltages of temperature sensors 211-214, respectively. As shown in equation 6, the output voltage is proportional to a weighted sum of the voltages of the temperature sensors, in which the weight of each sensor voltage is inversely proportional to the resistance of the respective variable resistor. Thus, the resistance of each variable resistor R1-R4 controls the weight of the respective temperature sensor 211-214.

Thus, the temperature manager 230 may assign different weights to the temperature sensors by controlling the resistances of the variable resistors R1-R4 accordingly. In this regard, the weight decoder 855 may control the resistance of each variable resistor R1-R4 based on a weight control signal received from the temperature manager 230. For example, the weight control signal may specify a weight for each temperature sensor. In this example, the weight decoder 855 may set the resistance of each variable resistor R1-R4 according to the specified weight for the respective temperature sensor. Thus, the multiplexer 820 not only allows the temperature manager 230 to select which of the temperature sensors 211-214 are coupled to the ADC 225, but also to control the weight of each temperature sensor.

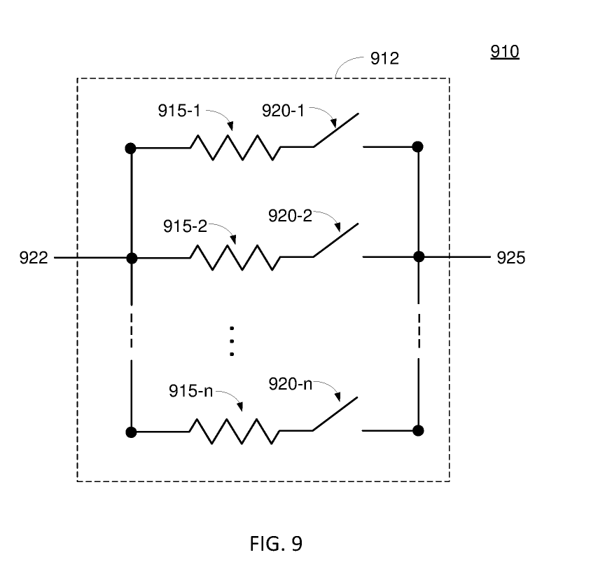

Each variable resistor R1-R4 may be implemented using a programmable resistor network. In this regard, FIG. 9 shows an exemplary implementation of a variable resistor 910 including a resistor network 912. Multiple instances of the variable resistor 910 may be used to implement the variable resistors R1-R4 shown in FIG. 8. In this example, the resistor network 912 includes a plurality of resistors 915-1 to 915-n and a plurality of switches 920-1 to 920-n, in which each of the resistors 915-1 to 915-n is coupled in series with a respective one of the switches 920-1 to 920-n. The resistors 915-1 to 915-n may have the same resistances or different resistances. Each resistor-switch pair is coupled between a first end 922 and a second end 925 of the variable resistor 910, as shown in FIG. 9. The first end 922 may be coupled to the respective temperature sensor, and the second end 925 may be coupled to the respective one of the switches 341-344 or the summing amplifier.

In operation, a resistor in the network 912 is selected by closing the respective switch, and a resistor in the network 912 is unselected by opening the respective switch. The resistance of the variable resistor 910 is determined by the resistances of the selected resistors 915-1 to 915-n. Thus, the weight decoder 855 (not shown in FIG. 9) may set the resistance of the variable resistor 910 to a resistance corresponding to a desired weight by selecting resistors in the network 912 accordingly. In this regard, the weight decoder 855 selects resistors in the network 912 by closing the switches corresponding to the selected resistors and opening the remaining switches.

In this example, the variable resistor 910 may be set to any one of a plurality of different resistances corresponding to a plurality of different weights, in which each one of the plurality of different resistances corresponds to a different selection of resistors in the network 912. The greater the number of resistors 915-1 to 915-n in the network, the greater the number of available resistances. Thus, increasing the number of resistors 915-1 to 915-n in the network 912 allows the temperature manager 230 to adjust the resistance of the variable resistor (and hence adjust the weight of the corresponding temperature sensor) with finer granularity.

In this example, the variable resistor 910 may also control whether the respective temperature sensor is selected. In this regard, if the respective temperature sensor is not selected, then the switch decoder 355 may open all of the switches 920-1 to 920-n in the network 912, thereby decoupling the respective temperature sensor from the ADC 225. Thus, in this example, the switches 341-344 shown in FIG. 8 may be omitted since their functions can be performed by the variable resistors.

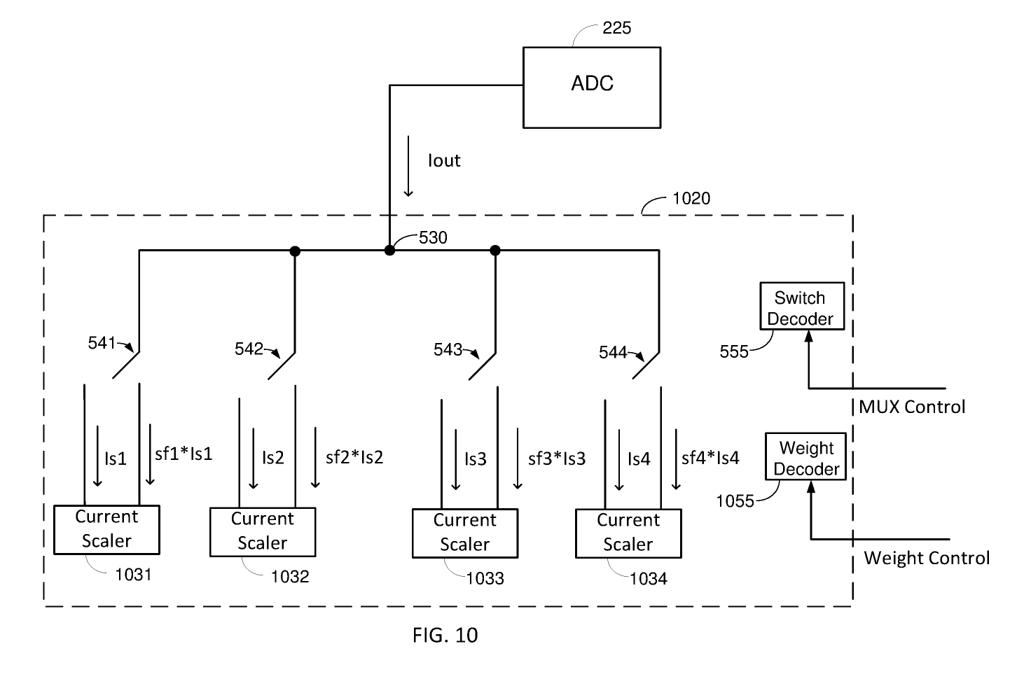

FIG. 10 shows another exemplary implementation of a multiplexer 1020 capable of providing a weighted sum of temperature readings from two or more of the temperature sensors 211-214. The multiplexer 1020 may be used to implement the multiplexer 220 in FIG. 2. In this example, each of the temperature sensors 211-214 provides a temperature reading in the form of a current Is1-Is4 that is a function of temperature at the respective sensor location.

The multiplexer 1020 is similar to the multiplexer 520 shown in FIG. 5, and further comprises a plurality of current scalers 1031-1034 and a weight decoder 1055. Each current scaler 1031-1034 is coupled to a respective one of the temperature sensors 211-214, and is configured to produce a scaled current that is equal to the current from the respective temperature sensor multiplied by a respective scaling factor. In FIG. 10, the scaling factors of current scalers 1031-1034 are given by sf1-sf4, respectively. The scaling factor of each current scaler 1031-1034 may be independently adjusted by the temperature manager 230, as discussed further below.

Each switch 541-544 controls whether the scaled current for the respective temperature sensor is coupled to the ADC 225. More particularly, the switch decoder 555 closes the switches 541-544 corresponding to the selected temperature sensors. The output current (denoted “Iout”) is the sum of the scaled currents of the selected temperature sensors.

In this example, the temperature manager 230 may assign different weights to the temperature sensors by controlling the scaling factors of the current scalers 1031-1034. For example, the temperature manager 230 may assign a higher weight to a temperature sensor by increasing the scaling factor of the respective current scaler, and assign a lower weight to a temperature sensor by decreasing the scaling factor of the respective current scaler. In this regard, the weight decoder 1055 may control the scaling factor of each current scaler 1031-1034 based on a weight control signal received from the temperature manager 230. For example, the weight control signal may specify a weight for each temperature sensor. In this example, the weight decoder 1055 may set the scaling factor of each current scaler 1031-1034 according to the specified weight for the respective temperature sensor. Thus, the multiplexer 1020 not only allows the temperature manager 230 to select which of the temperature sensors 211-214 are coupled to the ADC 225, but also to control the weight of each temperature sensor by controlling the scaling factor of the respective current scaler.

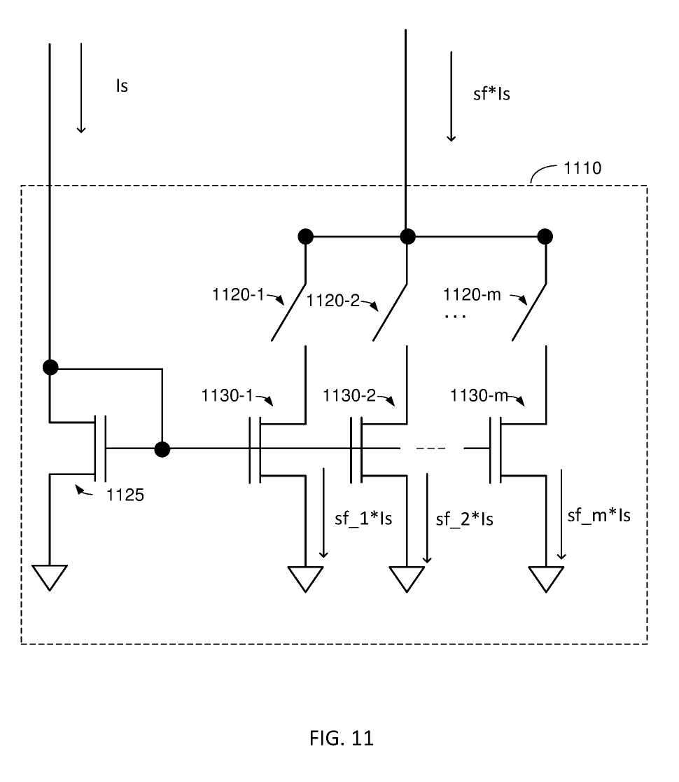

FIG. 11 shows an exemplary implementation of a current scaler 1110 that may be used to implement each of the current scalers 1031-1034 shown in FIG. 10. In this example, the current scaler 1110 includes a plurality of scaling transistors 1130-1 to 1130-m and a plurality of switches 1120-1 to 1120-m, in which each of the scaling transistors 1130-1 to 1130-m is coupled in series with a respective one of the switches 1120-1 to 1120-m. Each transistor-switch pair may be coupled between the ADC 225 and ground.

The current scaler 1110 also includes an input transistor 1125 having a drain coupled to the respective temperature sensor (not shown in FIG. 11), a gate coupled to the drain, and a source coupled to ground. The gate of the input transistor 1125 is coupled to the gate of each of the scaling transistors 1130-1 to 1030-m. The input transistor 1125 is configured to receive the sensor current Is from the respective temperature sensor, and each of the scaling transistors 1130-1 to 1030-m is configured to produce a respective replica current that is a scaled-version of the sensor current Is. The replica current of each scaling transistor is equal to the sensor current Is multiplied by a respective scaling factor. In FIG. 11, the scaling factors of the scaling transistors 1130 to 1130-m are given by sf_1 to sf_m, respectively. The scaling transistors may have the same scaling factors or different scaling factors. One or more of the scaling transistors may each have a scaling factor of one. The scaling factor of each scaling transistor may depend on the channel width of the scaling transistor relative to the channel width of the input transistor 1125. In this regard, the scaling factor of a scaling transistor may be set during the design of the current scaler 1110 by selecting the channel width of the scaling transistor according to a desired scaling factor. After fabrication of the current scaler, the scaling factor of each scaling transistor may be fixed.

In operation, a scaling transistor is selected by closing the respective switch, and a scaling transistor is unselected by opening the respective switch. The overall scaling factor of the current scaler 1110 is determined by a sum of the scaling factors of the selected scaling transistors. Thus, the weight decoder 1055 (not shown in FIG. 11) may set the scaling factor of the current scaler 1110 to a scaling factor corresponding to a desired weight by selecting scaling transistors accordingly such that the sum of the scaling factors of the selected scaling transistors equals the scaling factor corresponding to the desired weight. In this regard, the weight decoder 1055 selects scaling transistors by closing the switches corresponding to the selected scaling transistors and opening the remaining switches.

In this example, the current scaler 1110 may be set to any one of a plurality of different scaling factors corresponding to a plurality of different weights, in which each one of the plurality of different scaling factors corresponds to a different selection of scaling transistors. The greater the number of scaling transistors in the current scaler, the greater the number of available scaling factors. Thus, increasing the number of scaling transistors in the current scaler allows the temperature manager 230 to adjust the scaling factor of the current scaler (and hence adjust the weight of the corresponding temperature sensor) with finer granularity.

In this example, the current scaler 1110 may also control whether the respective temperature sensor is selected. In this regard, if the respective temperature sensor is not selected, then the switch decoder 555 may open all of the switches 1130-1 to 1130-m in the current scaler 1110. Thus, in this example, the switches 541-544 shown in FIG. 10 may be omitted since their functions can be performed by the current scalers.

In the example in FIG. 11, the input transistor 1125 and the scaling transistors 1130-1 to 1130-m are implemented with n-type field effect transistors. However, it is to be appreciated that the current scaler 1110 is not limited to this example, and that the input transistor 1125 and the scaling transistor 1130-1 to 1130-m may also be implemented with p-type field effect transistors.

As discussed above, the temperature manager 230 may estimate the temperature at a location on the chip based on a weighted sum of temperature readings from two or more temperature sensors. For example, the temperature manager 230 may estimate the temperature at a location on the chip according to equation 5 discussed above. The weights α₁ to α₄ of the temperature sensors for different locations may be determined using various techniques, examples of which are provided below.

For example, the weights assigned to the temperature sensors for a location on the chip may be determined based in part on distances of the temperature sensors from the location. In this example, a temperature sensor located closer to the location may be assigned a larger weight than a temperature sensor located farther from the location. In another example, the weights assigned to the temperature sensors for a location on the chip may be determined based in part on a temperature gradient map of the region 210. The temperature gradient map may be generated by running thermal simulations of the chip 200 or testing a physical chip. In this example, the gradient map may be used to estimate a change in temperature between the location and each of the temperature sensors. A temperature sensor with a smaller change in temperature may be assigned a higher weight than a temperature sensor with a larger change in temperature. Factors that may be considered in determining the weights assigned to the temperature sensors for a location on the chip may include shapes of the circuit blocks in the region 210, layout of the circuit blocks in the region 210, and/or placement of the temperature sensors. Other factors that may be considered are discussed further below.

The determined weights for a location on the chip may be refined based on thermal simulations of the chip 200 or tests on a physical chip. For example, a thermal simulation or test may be used to determine the temperatures at the locations of the temperature sensors and the location on the chip. The temperatures at the locations of the temperature sensors may then be input to equation 5 using the determined weights to compute an estimate of the temperature at the location on the chip. The estimated temperature at the location may then be compared with the temperature at the location determined by the simulation or test.

If the difference (error) between the estimated temperature at the location and the determined temperature at the location is equal to or below an error threshold, then the determined weights may be used for the location. If the difference (error) is above the error threshold, then one or more of the weights may be adjusted. After the weight adjustment, an estimate of the temperature at the location may be recomputed using the adjusted weights. The estimated temperature at the location may then be compared with the temperature at the location determined by the simulation or test. If the difference (error) between the estimated temperature at the location and the determined temperature at the location is equal to or below the error threshold, then the adjusted weights may be used for the location. If the difference (error) is above the error threshold, then one or more of the weights may be adjusted again, and the error may be recomputed to determine whether the error is reduced to a value equal to or below the error threshold. If the error is reduced to a value equal to or below the error threshold, then the readjusted weights may be used for the location. If not, then the above process may be repeated until the error is reduced to a value equal to or below the error threshold.

It is to be appreciated that the temperature at a location on the chip may be estimated using a subset of the temperature sensors instead of all of the temperature sensors. In this case, the weights assigned to the temperature sensors in the subset may be determined using the above techniques, in which the estimated temperature at the location on the chip is computed using the weighted sum of the temperatures at the locations of the temperature sensors in the subset.

The above techniques may be used to determine weights for each one of a plurality of different locations on the chip. For example, the different locations may correspond to different hotspot locations for different operating conditions of the chip (e.g., different use cases of the chip). The hotspot locations for the different operating conditions may be determined by running thermal simulations of the chip for each operating condition and looking for a location on the chip with a peak temperature for each operating condition.

The weights of the temperature sensors for a particular hotspot location may be determined using the above techniques under operating conditions corresponding to the hotspot location. The operating conditions may correspond to high activity (e.g., high operating frequency) of one or more processors (e.g., CPU, GPU, etc.) in the region 210. In this example, the weights of the temperature sensors for the hotspot location may be refined using the above techniques based on thermal simulations of the chip 200 under the operating conditions corresponding to the hotspot location. In this case, the weights for the temperature sensors may correspond to a particular location on the chip (i.e., the hotspot location) and certain operating conditions (i.e., the operating conditions corresponding to the hotspot location).

The weights for each of the different locations on the chip may be stored in a lookup table in a memory on the chip. The memory may be an internal memory in the temperature manager 230 or a memory coupled to the temperature manager 230. In this example, the temperature manager 230 may estimate the temperature at a particular location on the chip by retrieving (looking up) the corresponding weights from the lookup table in the memory, and sending a weight control signal to the multiplexer 220 according to the retrieved weights. The multiplexer 220 may then set the resistances of the variable resistors R1-R4 or set the current scaling factors of the current scalers 1031-1034 according to the received weight control signal, as discussed above.

In certain aspects, the temperature manager 230 may estimate the temperature at a location on the chip based on a weighted sum of the temperature readings from all of the temperature sensors or a subset of the temperature sensors, as discussed above, and compare the estimated temperature with a temperature threshold. The temperature threshold may correspond to an upper temperature boundary for safe operation of the chip. If the estimated temperature exceeds the temperature threshold, then the temperature manager 230 may perform temperature mitigation, as discussed above.

In certain aspects, the temperature manager 230 may estimate the temperature at a location on the chip based on a weighted sum of temperature readings, as discussed above, and compare the estimated temperature with the second temperature threshold at step 630 in FIG. 6. At step 640, the temperature manager 230 may determine whether the estimated temperature exceeds the second threshold. If the estimated temperature does not exceed the second temperature threshold, then the temperature manager 230 repeats steps 630 and 640. For example, the temperature manager 230 may repeat steps 630 and 640 using an estimated temperature at another location on the chip or using an individual temperature reading from one of the temperature sensors. If the estimated temperature exceeds the second temperature threshold, then the temperature manager 230 may perform temperature mitigation at step 650, as discussed above.

In certain aspects, the temperature management system may include multiple multiplexers. For example, the temperature management system may include multiple instances of multiplexer 220 and ADC 225 to monitor temperature at different locations. In this example, each of the multiplexers may be configured to provide a weighted sum of the temperature readings from all of the temperature sensors or a subset of the temperature sensors, and each of the ADCs may be configured to convert the weighted sum from a respective one of the multiplexers into the digital domain for processing by the temperature manager 230. In this example, the temperature manager 230 may set the weights of the multiplexers differently so that the weighted sum from each multiplexer corresponds to a different location. This allows the temperature manager 230 to monitor the temperature at the different locations using the multiple multiplexers instead of using a single multiplexer that is time multiplexed between the different locations (which may require changing the weights of the single multiplexer for each location).

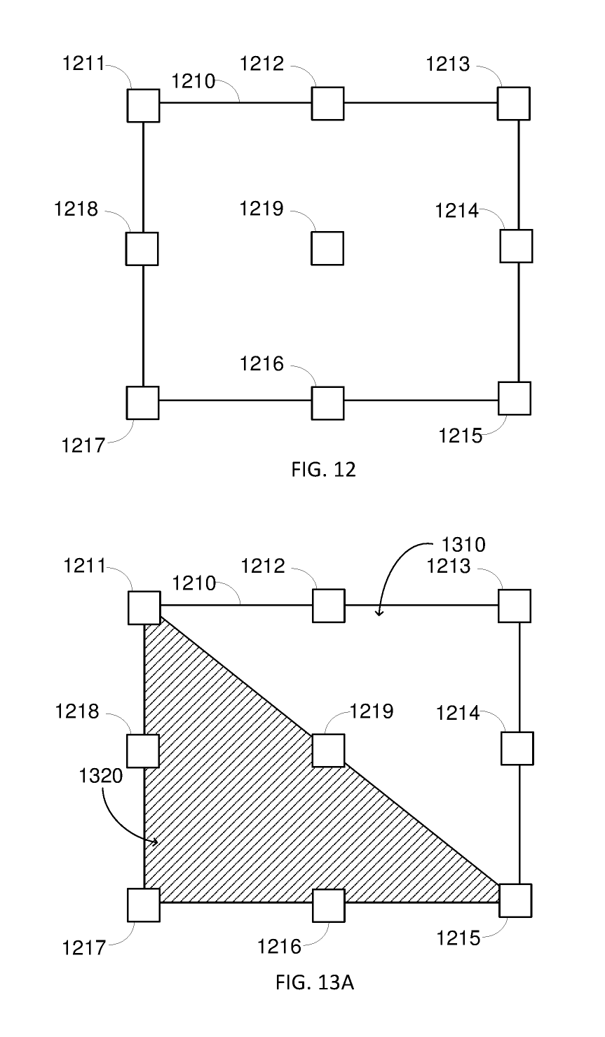

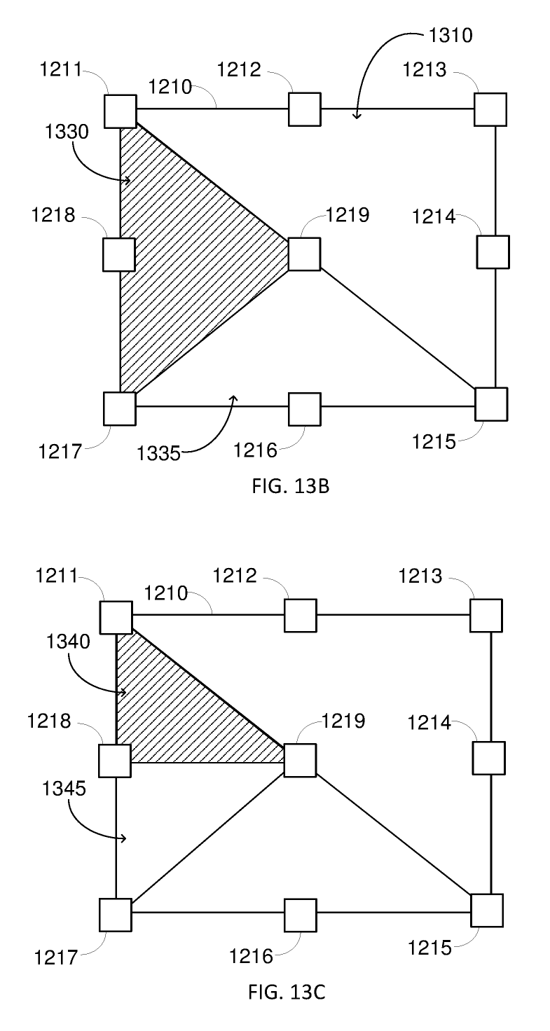

A binary search algorithm may be performed to locate a hotspot on a chip according to certain aspects. In this regard, an exemplary binary search is described below with reference to FIGS. 12, 13A, 13B and 13C.

FIG. 12 shows an exemplary layout of temperature sensors 1211-1219 on a chip. The temperature sensors 1211-1219 may be coupled to the multiplexer 220 shown in FIG. 2. In this example, the multiplexer 220 has multiple inputs, in which each of the inputs is coupled to a respective one of the temperature sensors 1211-1219. In operation, the multiplexer 220 selectively couples one or more of the temperature sensors 1211-1219 to the ADC 225 (shown in FIG. 2) under the control of the temperature manager 230, as discussed above. The multiplexer 220 may provide the ADC 225 with an average of the temperature readings from the selected temperature sensors 1211-1219, or a sum of the temperature readings from the selected temperature sensors 1211-1219, as discussed above. The sum of the temperature readings may be weighted. The multiplexer 220 may also couple an individual temperature sensor to the ADC 225.

An exemplary binary search will be now described with reference to the exemplary temperature sensor layout shown in FIG. 12. However, it is to be appreciated that the binary search is not limited to the exemplary temperature sensor layout shown in FIG. 12, and may be applied to other temperature sensor layouts.

In a first step, the region 1210 is divided (partitioned) into two smaller triangular regions 1310 and 1320, as shown in FIG. 13A. The regions 1310 and 1320 may be of approximately equal size. The temperature manager 230 may then compute a temperature for each region 1310 and 1320. For example, the temperature manager 230 may compute the temperature for region 1310 by instructing the multiplexer 220 to select temperature sensors 1211, 1212, 1213, 1214, 1215 and 1219, and computing the temperature for region 1310 using temperature readings from the selected sensors. In one example, the temperature manager 230 may use an average or sum of the temperature readings from the selected temperature sensors as the temperature for region 1310. In another example, the temperature manager 230 may compute an estimate of the temperature at a location within region 1310 based on an average or sum of the temperature readings from the selected temperature sensors, as discussed above, and use the resulting estimated temperature as the temperature for region 1310. The location within region 1310 may correspond to a centroid of region 1310 or another location within region 1310. The sum of the temperature reading may be weighted, as discussed above.

The temperature manager 230 may compute the temperature for region 1320 in a similar manner using temperature readings from temperature sensors 1211, 1219, 1215, 1216, 1217 and 1218.

After computing the temperatures for regions 1310 and 1320, the temperature manager 230 may compare the temperature for region 1310 with the temperature reading for region 1320 to determine which one is higher. The temperature manager 230 may then narrow the search to the region having the highest temperature. In the example in FIG. 13A, region 1320 (shaded in FIG. 13A) has the highest temperature among regions 1310 and 1320.

In a subsequent step, the temperature manager 230 divides (partitions) the region with the highest temperature in the previous step into two smaller regions, as shown in FIG. 13B. In this example, region 1320 from the previous step is divided (partitioned) into triangular regions 1330 and 1335. The regions 1330 and 1335 may be of approximately equal size. The temperature manager 230 may then compute a temperature for each region 1330 and 1335. For example, the temperature manager 230 may compute the temperature for region 1330 using temperature readings from temperature sensors 1211, 1219, 1217 and 1218, and compute the temperature for region 1335 using temperature readings from temperature sensors 1217, 1219, 1215 and 1216, as discussed above.

After computing the temperatures for regions 1330 and 1335, the temperature manager 230 may compare the temperature for region 1330 with the temperature for region 1335 to determine which one is higher. The temperature manager 230 may then narrow the search to the region having the highest temperature. In the example in FIG. 13B, region 1330 (shaded in FIG. 13B) has the highest temperature among regions 1330 and 1335.

In a subsequent step, the temperature manager 230 divides (partitions) the region with the highest temperature in the previous step into two smaller regions, as shown in FIG. 13C. In this example, region 1330 from the previous step is divided (partitioned) into triangular regions 1340 and 1345. The regions 1340 and 1345 may be of approximately equal size. The temperature manager 230 may then compute a temperature for each region 1340 and 1345. For example, the temperature manager 230 may compute the temperature for region 1340 using temperature readings from temperature sensors 1211, 1219 and 1218, and compute the temperature for region 1345 using temperature readings from temperature sensors 1218, 1219 and 1217, as discussed above.

After computing the temperatures for regions 1340 and 1345, the temperature manager 230 may compare the temperature for region 1340 with the temperature for region 1345 to determine which one is higher. The temperature manager 230 may then narrow the search to the region having the highest temperature. In the example in FIG. 13C, region 1340 (shaded in FIG. 13C) has the highest temperature among regions 1340 and 1345.

Thus, in each successive step, the binary search is narrowed to a smaller region. For example, in each successive step, the binary search may be narrowed to a region that is approximately half the size of the region in the previous step. In this example, the search area is reduced in half in each successive step. The binary search may continue until the search is narrowed to a region of a certain size. At this point, the temperature manager 230 may estimate the hotspot temperature as the temperature for that region. Alternatively, the temperature manager 230 may individually check the temperature reading from each of the temperature sensors corresponding to the region, and use the highest temperature reading as the estimate of the hotspot temperature. The temperature sensors corresponding to the region may include temperature sensors lying along the perimeter (boundary) of the region and/or within the region. In another example, the temperature manager 230 may estimate the temperature at two or more different locations within the region using any of the techniques discussed above. In this example, the temperature manager 230 may use the highest estimated temperature as the estimate of the hotspot temperature.

After estimating the hotspot temperature using the binary search, the temperature manager 230 may compare the estimated hotspot temperature with a temperature threshold (e.g., the second temperature threshold at step 630 in FIG. 6). The temperature threshold may correspond to an upper temperature boundary for safe operation. If the estimated temperature exceeds the temperature threshold, then the temperature manager 230 may perform temperature mitigation, as discussed above.

The binary search allows the temperature manager 230 to quickly locate a hotspot on the chip and accurately estimate the temperature of the hotspot. This reduces the negative impact of temperature management on performance (e.g., processor performance) by reducing the amount of unnecessary temperature mitigations (which reduce performance), as discussed further below.

In a conventional temperature management system, temperature is only determined at the temperature sensor locations, which can be located away from a hotspot. To account for this, the convention temperature manager adds a temperature margin to a temperature reading to ensure that the hotspot temperature does not exceed the temperature threshold. The temperature margin is typically based on the worst case difference between the temperature reading and the hotspot temperature. In many cases, the actual difference between the temperature reading and the hotspot temperature is less than the temperature margin. Thus, most of the time, the temperature margin causes the temperature manager to initiate temperature mitigation when the actual hotspot temperature is still below the temperature threshold, resulting in unnecessary decreases in performance most of the time. By allowing the temperature manager 230 to more accurately estimate the hotspot temperature, the binary search allows the temperature manager 230 to reduce the temperature margin, which reduces the amount of unnecessary temperature mitigations, and therefore reduces the negative impact on performance.

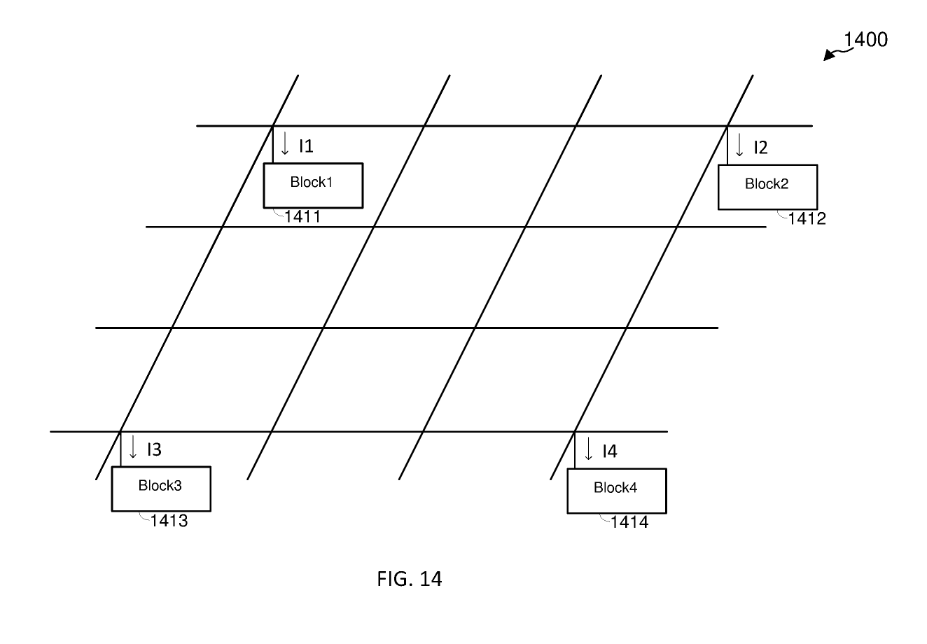

The exemplary search algorithm is not limited to temperature sensors. For example, the search algorithm may be applied to current sensors used to monitor current draws from a power distribution network. In this regard, FIG. 14 shows an example of a power distribution network 1400 used to power multiple blocks on a chip from a power source (e.g., battery). FIG. 14 shows an example of four blocks 1411-1414 coupled to the power distribution network 1400. However, it is to be appreciated that a larger number of blocks may be coupled to the power distribution network.

In this example, the blocks 1411-1414 draw currents I1-I4 from the power distribution network 1400. The amount of current drawn by a block may depend, for example, on whether the block is in an active state or an idle state, the operating frequency of the block, etc. For instance, the current drawn by a block may increase as the operating frequency of the block increases.

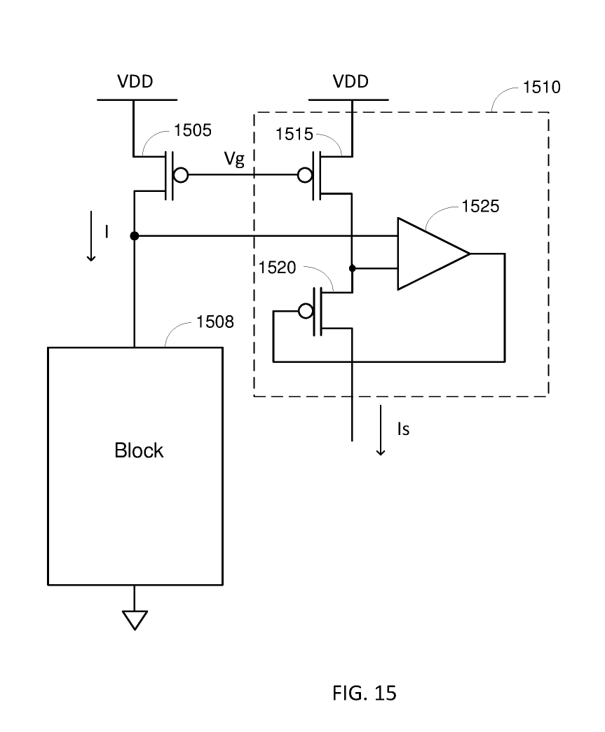

The currents I1-I4 drawn by the blocks 1411-1414 may be monitored using current sensors integrated on the chip. In this regard, FIG. 15 shows an exemplary implementation of a current sensor 1510 configured to measure the amount of current drawn by block 1508. In this example, the current sensor 1510 includes a first transistor 1515 (e.g., PFET), a second transistor 1520 (e.g., PFET), and a feedback amplifier 1525. The gate of the first transistor 1515 is coupled to the gate of a power transistor 1505. The power transistor 1505 (e.g., PFET) functions as a head switch configured to couple the block 1508 to the power distribution network when the block is active. The source of the first transistor 1515 may be coupled to the power distribution network. The source of the second transistor 1520 is coupled to the drain of the first transistor 1515. The sensor current (denoted “Is”) of the current sensor 1510 is taken from the drain of the second transistor 1520, as shown in FIG. 15.

The amplifier 1525 has a first input coupled to the drain of the power transistor 1505, a second input coupled to the drain of the first transistor 1515, and an output coupled to the gate of the second transistor 1520. In operation, the amplifier 1525 senses the difference (error) between the drain voltages of the power transistor 1505 and the first transistor 1515, and adjusts the gate voltage of the second transistor 1520 in a direction that reduces the different (error) between the drain voltages of the power transistor 1505 and the first transistor 1515. In other words, the amplifier 1525 is coupled in a feedback loop that forces the drain voltage of the first transistor 1515 to be approximately equal to the drain voltage of the power transistor 1505. This helps ensure that the current (i.e., sensor current Is) flowing through the first and second transistors 1515 and 1520 tracks the current flowing through the power transistor 1505, and therefore provides a measurement of the current flowing through the power transistor 1505 into block 1508 (i.e., current drawn by block 1508).

The sensor current Is may be a scaled-down version of the current flowing through the power transistor 1505 into block 1508. In this example, the ratio of the sensor current to the current flowing through the power transistor 1505 may be set by the ratio of the channel width of the first transistor 1515 to the channel width of the power transistor 1505. In certain aspects, the ratio may be 1 to 100 or greater so that the sensor current is much lower than the current flowing through the power transistor 1505. Making the sensor current Is low reduces the power consumption of the current sensor.

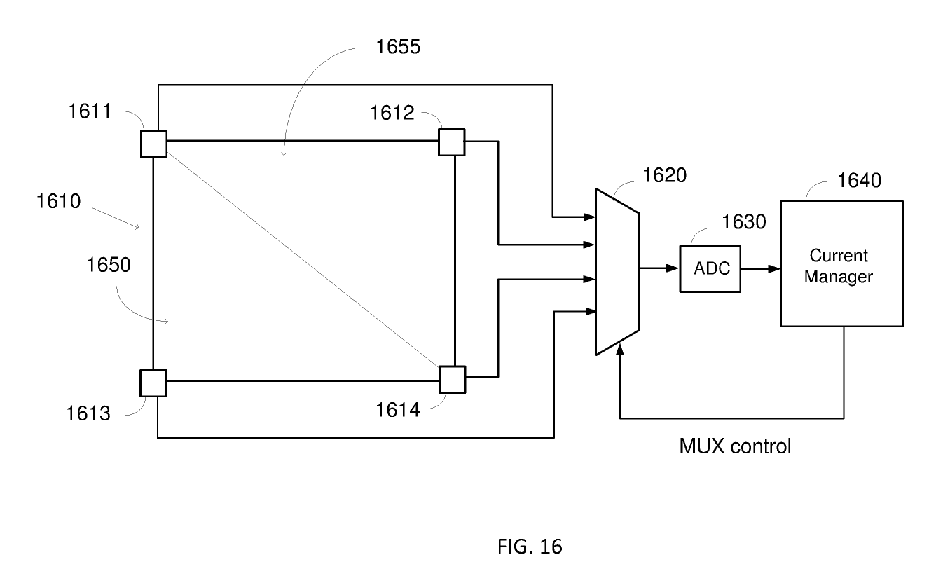

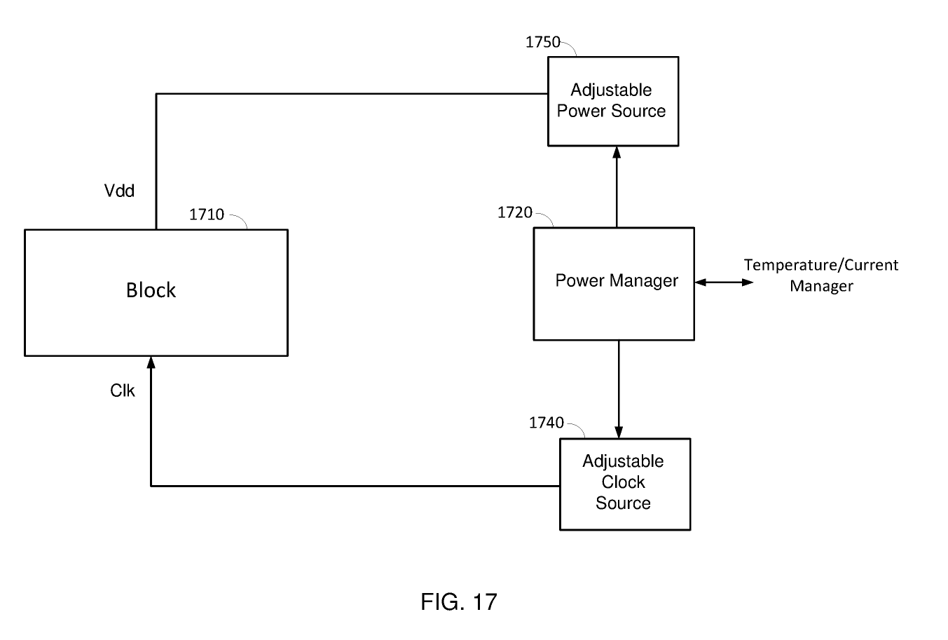

FIG. 16 shows an example of a current monitoring system including current sensors 1611-1614 configured to measure the currents drawn by blocks 1411-1414 shown in FIG. 14. Each of the current sensors 1611-1614 may be implemented using the exemplary current sensor 1510 shown in FIG. 15. The current monitoring system also includes a multiplexer 1620, an ADC 1630, and a current manager 1640. The multiplexer 1620 has multiple inputs and an output, in which each input is coupled to a respective one of the current sensors 1611-1614, and the output is coupled to the ADC 1630. The ADC 1630 is configured to convert the output signal of the multiplexer 1620 into a digital signal and output the digital signal to the current manager 1640.

The multiplexer 1620 is configured to selectively couple one or more of the current sensors 1611-1614 to the ADC 1630 at a time based on a multiplexer control signal (denoted “MUX control” in FIG. 16) from the current manager 1640. For example, the current manager 1640 may command the multiplexer 1620 to couple each current sensor 1611-1614 to the ADC 1630 one at a time. In this example, the ADC 1630 receives a current reading (current measurement) from each current sensor one at a time. The ADC 1630 converts each current reading into digital form, and outputs each current reading in digital form to the current manager 1630.

In this example, the current manager 1640 may compare a current reading from one of the current sensors with a current threshold, and perform current mitigation if the current reading exceeds the current threshold. The current threshold may correspond to a maximum current that can be safely supplied to the corresponding block. If the current reading exceeds the current threshold, then the current manager 1640 may reduce the current drawn by the corresponding block. For example, the current manager 1640 may reduce the current by reducing the operating frequency of the block. The current manager 1640 may perform the above steps for each one of the current sensors.

In another example, the current manager 1640 may command the multiplexer 1620 to couple two or more of the temperature sensors 1611-1614 to the ADC 1630 at the same time. In this example, the multiplexer 1620 may be configured to sum the current readings (current measurements) from the two or more current sensors, and output the sum of the current readings to the ADC 1630. The ADC 1630 may then convert the sum of the current readings into digital form, and output the sum of the current readings in digital form to the current manager 1640. In this example, the multiplexer 1620 may be implemented using the multiplexer 520 shown in FIG. 5 or the multiplexer 1020 shown in FIG. 10. The exemplary multiplexer 520 shown in FIG. 5 provides a sum of the current readings from the selected current sensors by shorting the selected current sensors together, as discussed above.

In this example, the current manager 1640 may compare the sum of the current readings from the current sensors with a current threshold, and perform current mitigation if the current threshold exceeds the current threshold. The current threshold may correspond to a maximum total current that can be supplied to the blocks. If the sum of the current readings exceeds the current threshold, then the current manager 1640 may reduce the total current drawn by the blocks. For example, the current manager 1640 may reduce the total current by reducing the operating frequencies of one or more of the blocks, and/or shutting down one or more of the blocks.

The exemplary binary search algorithm discussed above may be performed using the current sensors 1611-1614 to find a largest current draw on the power distribution network 1400. In a first step, a region 1610 is divided (partitioned) into two smaller regions. The region 1610 may have a boundary defined by the current sensors 1611-1614, as shown in FIG. 16. In this example, the region 1610 may be divided into a first region 1650 (e.g., lower triangle) and a second region 1655 (e.g., upper triangle). The current manager 1640 may then compute a current for each region 1650 and 1655. For example, the current manager 1640 may compute the current for region 1650 by instructing the multiplexer 1620 to select current sensors 1611, 1613 and 1614, and using the sum of the current readings from current sensors 1611, 1613 and 1614 as the current for region 1650. The current manager 1640 may compute the current for region 1655 by instructing the multiplexer 1620 to select current sensors 1611, 1612 and 1614, and using the sum of the current readings from current sensors 1611, 1612 and 1614 as the current for region 1655.

After computing the currents for regions 1650 and 1655, the current manager 1640 may compare the current for region 1650 with the current for region 1655 to determine which one is higher. The current manager 1640 may then continue the search in the region having the highest current.

For example, if the current monitoring system includes additional current sensors (not shown in FIG. 16), then the current manager 1640 may divide the region 1650 or 1655 with the highest current into two smaller regions, and compute a current for each of the smaller regions. The current for each of the smaller regions may be the sum of the current readings from current sensors corresponding to the region (e.g., current sensors on the boundary of the region and/or within the region). The current manager may then determine which of the two smaller regions has the highest current, and continue the search in the region with the highest current. The current manager 1640 may continue the search in the above manner until a region of a certain size is reached. At this point, the current manager 1640 may estimate the largest current draw as the current for the region. Alternatively, the current manager 1640 may individually check the current reading from each current sensor corresponding to the region, and use the highest current reading as the estimate of the largest current draw.

In this example, the current manager 1640 may compare the largest current draw with a current threshold, and perform current mitigation if the largest current draw exceeds the current threshold. If the largest current draw exceeds the current threshold, then the current manager 1640 may reduce the largest current draw by, for example, reducing the operating frequency of a block contributing to the largest current draw.

FIG. 17 shows an exemplary power management system for managing power for one or more blocks on a chip. For ease of illustration, one circuit block 1710 is shown in FIG. 17. The temperature manager 230 and/or the current manager 1640 discussed above may use the power management system to perform temperature mitigation and/or current mitigation, as discussed further below. In this regard, the block 1710 may be located in region 210 and/or region 1610 discussed above. The power management system manager includes a power manager 1720, an adjustable clock source 1740, and an adjustable power source 1750.

The adjustable clock source 1740 is configured to generate a clock signal for the block 1710 (e.g., processor), and to adjust the frequency of the clock signal (denoted “Clk”) under the control of the power manager 1720. The clock signal is output to the block 1710, which may use the clock signal for switching (toggling) transistors in the block. In this example, the frequency of the clock signal may correspond to an operating frequency of the block. Thus, the power manager 1720 can adjust (scale) the operating frequency of the block by adjusting the frequency of the clock signal output by the clock source 1740.

The adjustable power source 1750 is configured to provide an adjustable supply voltage (denoted “Vdd”) to the block 1710 (e.g., via the power distribution network 1400), and to adjust the supply voltage Vdd under the control of the power manager 1720. The power source 1750 may comprise a power management integrated circuit (PMIC). The block 1710 may use the supply voltage Vdd to power devices (e.g., transistors) in the block. Thus, the power manager 1720 can adjust (scale) the supply voltage of the block 1710 by adjusting the supply voltage Vdd provided to the block 1710 from the power source 1750.

The power manager 1720 may manage power based on instructions from the temperature manager 230. For example, if the temperature manager 230 makes a determination to perform temperature mitigation, then the temperature manager 230 may instruct the power manager 1720 to mitigate temperature for the block. In response, the power manager 1720 may reduce the frequency and/or supply voltage of the block 1710. Reducing the operating frequency, the supply voltage, or both reduces temperature by reducing the dynamic power dissipation of the block 1710. The power manager 1720 reduces the frequency of the block 1710 by reducing the frequency of the clock signal output by the adjustable clock source 1740 and reduces the supply voltage of the block by reducing the supply voltage output by the adjustable power source 1750.

The power manager 1720 may also manage power based on instructions from the current manager 1640. For example, if the current manager 1640 makes a determination to reduce current to the block 1710, then the current manager 1640 may instruct the power manager 1720 to mitigate current for the block. In response, the power manager may reduce the frequency of the block 1710. This reduces the current drawn by the block 1710 by reducing the switching activity of the block 1710. The power manager 1720 reduces the frequency of the block 1710 by reducing the frequency of the clock signal output by the adjustable clock source 1740.

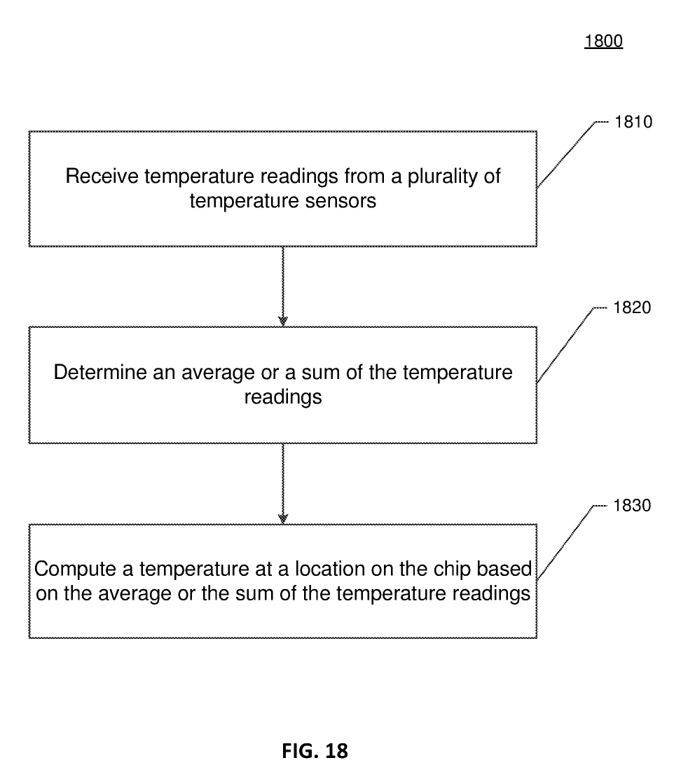

FIG. 18 shows a method 1800 for temperature monitoring according to certain aspects of the present disclosure. The method 1800 may be performed by the multiplexer 220 and the temperature manager 230.

In step 1810, temperature readings are received from a plurality of temperature sensors on a chip. For example, the temperature readings may be received by the multiplexer 220. Each temperature reading may be in the form of a voltage or a current that is a function of the temperature at the location of the respective one of the temperature sensors (e.g., temperature sensors 211-214).

In step 1820, an average or a sum of the temperature readings from the temperature sensors is determined. For example, the temperature readings may be averaged or summed by the multiplexer 220. In one example, the sum of the temperature readings may be determined by shorting the temperature sensors (e.g., using the multiplexer 520 shown in FIG. 5). In another example, the sum of the temperature reading may be determined using a summing amplifier (e.g., summing amplifier 432). The sum may be a weighted sum of the temperature readings, in which weights may assigned to the temperature sensors based on, for example, shapes of the blocks on the chip, layout of the blocks on the chip, placement of the temperature sensors, etc.

In step 1830, a temperature at a location on the chip is computed based on the average or sum of the temperature readings. For example, the temperature at the location may be determined by the temperature manager 230. The location may be located at approximately a centroid of the locations of the temperature sensors, an estimated hotspot location on the chip, or another location on the chip.

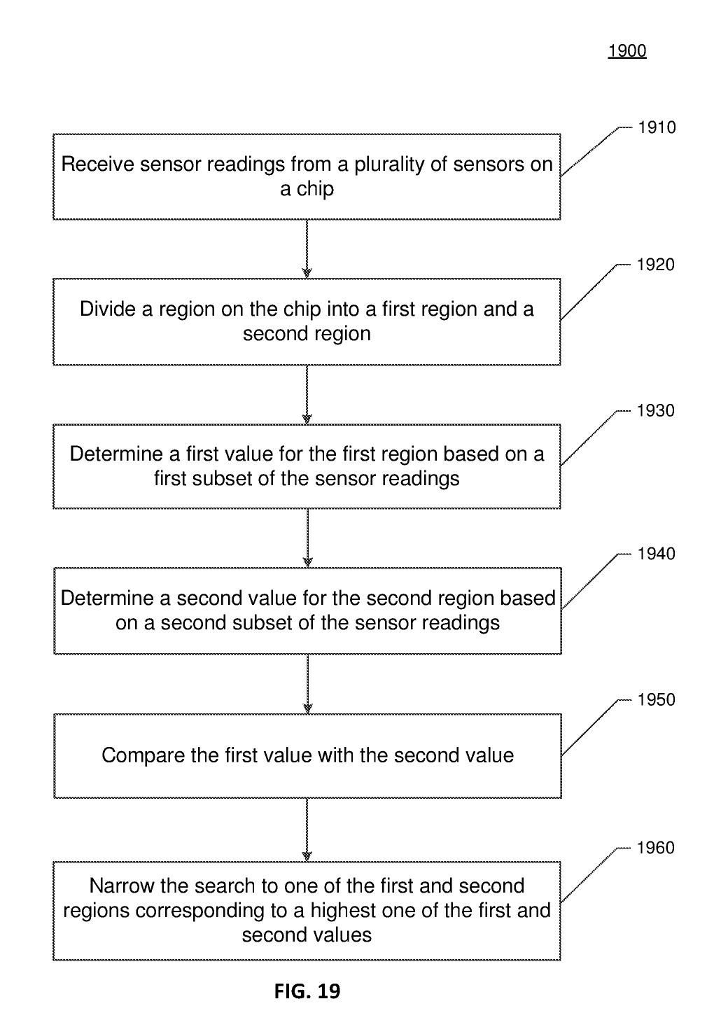

FIG. 19 shows a method 1900 for performing a search (e.g., binary search) according to certain aspects.

In step 1910, sensor readings are received from a plurality of sensors on a chip. The sensors may comprise temperature sensors (e.g., temperature sensors 1211-1219) or current sensors (e.g., current sensors 1611-1614).

In step 1920, a region of the chip is divided into a first region and a second region. For example, the region (e.g., 1210) may be divided into two regions (e.g., regions 1310 and 1320) of approximately equal area.

In step 1930, a first value is computed for the first region based on a first subset of the sensor readings. For example, the first value for the first region (e.g., region 1310) may be computed based on an average or sum of the sensor readings in the first subset (e.g., sensors 1211, 1212, 1213, 1214, 1215 and 1219).

In step 1940, a second value is computed for the second region based on a second subset of the sensor readings. For example, the second value for the second region (e.g., region 1320) may be computed based on an average or sum of the sensor readings in the second subset (e.g., sensors 1211, 1218, 1217, 1216, 1215 and 1219). The first and second subsets of sensor readings may be different.

In step 1950, the first value is compared with the second value.

In step 1960, the search is narrowed to one of the first and second regions corresponding to a highest one of the first and second values. For example, the search may be continued in the region with the highest value by dividing the region into two smaller regions and repeating the above steps for the two smaller regions.

The temperature manager 230, the current manager 1640 and the power manager 1720 may be implemented with one or more processors and one or more memories storing instructions that, when executed by the one or more processors, cause the one or more processors to perform the operations discussed herein. The one or more processors may include general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any combination thereof. The one or more memories may be internal to the one or more processors and/or external to the one or more processors. The one or more memories may include any suitable computer-readable media, including RAM, ROM, Flash memory, EEPROM, etc.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A system comprising:
a plurality of temperature sensors on a chip;
a multiplexer having a plurality of inputs and an output, wherein each of the inputs is coupled to a respective one of the temperature sensors;
an analog-to-digital converter (ADC) coupled to the output of the multiplexer, wherein the ADC is configured to convert an output signal from the output of the multiplexer into a digital signal; and
a temperature manager configured to instruct the multiplexer to select one or more of the temperature sensors, to receive the digital signal from the ADC, and to compute a temperature based on the digital signal;
wherein the multiplexer is configured to generate the output signal based on one or more temperature readings from the selected one or more of the temperature sensors.

2. The system of claim 1, wherein the temperature manager is configured to instruct the multiplexer to select two or more of the temperature sensors, and the multiplexer is configured to generate the output signal based on an average or a sum of the temperature readings from the selected two or more of the temperature sensors.

3. The system of claim 2, wherein the computed temperature is for a location on the chip located at approximately a centroid of the locations of the selected two or more of the temperature sensors.

4. The system of claim 2, wherein the multiplexer comprises a plurality of switches, each of the switches is coupled between a respective one of the temperature sensors and the output of the multiplexer, and the multiplexer is configured to close the switches coupled to the selected two or more of the temperatures sensors.

5. The system of claim 2, wherein the multiplexer comprises a plurality of segments, each of the segments comprises a respective switch and a respective resistor coupled in series, each of the segments is coupled between a respective one of the temperature sensors and the output of the multiplexer, and the multiplexer is configured to close the switches of the segments coupled to the selected two or more of the temperatures sensors.

6. The system of claim 2, wherein the temperature manager is configured to compare the computed temperature with a temperature threshold, and to initiate temperature mitigation if the computed temperature exceeds the temperature threshold.

7. The system of claim 1, wherein the temperature manager is configured to instruct the multiplexer to select two or more of the temperature sensors, and the multiplexer is configured to generate the output signal based on a weighted sum of the temperature readings from the selected two or more of the temperature sensors.

8. The system of claim 7, wherein the multiplexer is configured to generate the output signal by applying a different weight to the temperature reading from each of the selected two or more of the temperature sensors.

9. The system of claim 8, wherein the computed temperature is for a location on the chip, and the temperature manager is configured to select the weight for each of the selected two or more of the temperature sensors based on the location.

10. The system of claim 9, wherein the temperature manager is configured to select the weight for each of the selected two or more of the temperature sensors by retrieving the weight for each of the selected two or more of the temperature sensors from a lookup table stored in a memory based on the location, the lookup table including two or more weights for each one of a plurality of different locations.

11. The system of claim 8, wherein the multiplexer comprises a plurality of variable resistors, each of the variable resistors is coupled between a respective one of the temperature sensors and the output of the multiplexer, and, for each of the selected two or more of the temperature sensors, the multiplexer is configured to set a resistance of the variable resistor coupled to the temperature sensor based on the respective weight.

12. The system of claim 8, wherein the multiplexer comprises a plurality of current scalers, each of the current scalers is coupled between a respective one of the temperature sensors and the output of the multiplexer, and, for each of the selected two or more of the temperature sensors, the multiplexer is configured to set a scaling factor of the current scaler coupled to the temperature sensor based on the respective weight.

13. A method for temperature monitoring, comprising:
receiving temperature readings from a plurality of temperature sensors on a chip;
determining an average or a sum of the temperature readings from the temperature sensors; and
computing a temperature at a location on the chip based on the average or sum of the temperature readings.

14. The method of claim 13, wherein the location is located approximately at a centroid of the locations of the plurality of temperature sensors.

15. The method of claim 13, wherein determining the average or the sum of the temperature readings comprises:
applying a different weight to the temperature reading from each of the temperature sensors; and
determining a sum of the weighted temperature readings;
wherein computing the temperature at the location on the chip is based on the sum of the weighted temperature readings.

16. The method of claim 15, further comprising selecting the weight for each of the temperature sensors by retrieving the weight for each of the temperature sensors from a lookup table stored in a memory based on the location, the lookup table including two or more weights for each one of a plurality the different locations.

17. The method of claim 15, wherein applying a different weight to the temperature reading from each of the temperature sensors comprises, for each of the temperature sensors, setting a resistance of a variable resistor coupled to the temperature sensor based on the respective weight.

18. The method of claim 15, wherein applying a different weight to the temperature reading from each of the temperature sensors comprises, for each of the temperature sensors, setting a scaling factor of a current scaler coupled to the temperature sensor based on the respective weight.

19. The method of claim 13, wherein the location on the chip is different from a location of each one of the temperature sensors.

20. A method for performing a search, comprising:
receiving sensor readings from a plurality of sensors on a chip;
dividing a region of the chip into a first region and a second region;
determining a first value for the first region based on a first subset of the sensor readings;
determining a second value for the second region based on a second subset of the sensor readings;
comparing the first value with the second value;
narrowing the search to one of the first and second regions corresponding to a highest one of the first and second values.

21. The method of claim 20, wherein the sensors comprise temperature sensors, the first value comprises a first temperature, and the second value comprises a second temperature.

22. The method of claim 21, wherein the search is for a hotspot location on the chip.

23. The method of claim 20, wherein the sensors comprise current sensors, the first value comprises a first current, and the second value comprises a second current.

24. The method of claim 23, wherein the search is for a block on the chip drawing a largest current from a power distribution network.

25. The method of claim 20, wherein the first region and the second region have approximately a same area.

26. The method of claim 20, wherein determining the first value for the first region comprises determining an average or a sum of the sensor readings in the first subset of the sensor readings.

27. The method of claim 20, further comprising:
dividing the one of the first and second regions corresponding to the highest one of the first and second values into a third and fourth region;
determining a third value for the third region based on a third subset of the sensor readings;
determining a fourth value for the fourth region based on a fourth subset of the sensor readings;
comparing the third value with the fourth value;
narrowing the search to one of the third and fourth regions corresponding to a highest one of the third and second values.

28. The method of claim 27, wherein determining the third value for the third region comprises determining an average or a sum of the sensor readings in the third subset of the sensor readings.
